(19) United States
(12) Patent Application Publication
(10) Pub. No.: US 2026/0346195 A1
(43) Pub. Date: Nov. 5, 2026

(54) HYBRID ELECTROCHEMICAL SYSTEMS AND METHODS FOR CARBON DIOXIDE CAPTURE

(71) Applicants: SCOTT NIELSON, Salt Lake City, UT (US); SUPERDAC, SAS, Nanterre (FR); MARBLE I, PARIS (FR)

(72) Inventors: Silvia Pugliese, Naterre (FR); Lipsa Nag, Naterre (FR); Vedika Kulkarni, Naterre (FR); Alessandro Perazio, Naterre (FR)

(21) Appl. No.: 19/486,276

(22) PCT Filed: May 22, 2024
(86) PCT No.: PCT/US2024/030660

§ 371 Date: Nov. 20, 2025

Related U.S. Application Data
(60) Provisional application No. 63/468,116, filed on May 22, 2023.

(51) Int. Cl. B01D 53/62; B01D 53/14; B01D 61/42

(52) U.S. Cl. CPC B01D 53/62; B01D 53/1475; B01D 61/42; B01D 2257/504; B01D 2258/06

(57) ABSTRACT

A method for capturing carbon dioxide (CO₂) from a gas includes a first step of hydrating the CO₂ from the gas to dissolve the CO₂ into an electrolyte solution and form a CO₂-rich electrolyte solution, and a second step including a first sub-step and a second sub-step. The first sub-step includes feeding an electrochemical device with the CO₂-rich electrolyte solution obtained from the first step, the first sub-step being carried out so as deplete the CO₂-rich electrolyte solution to form a depleted electrolyte solution by applying a bias voltage between electrodes including an anode and a cathode of the electrochemical device and capturing the CO₂-derived ions and CO₂ gas by the electrodes. The second sub-step involves interrupting, removing, or inverting the bias voltage to release the CO₂-derived ions and CO₂ gas from the electrodes which recombine to regenerate gaseous CO₂.

### CROSS-REFERENCE TO RELATED APPLICATIONS

This application is a national phase entry under 35 U.S.C. § 371 of International Patent Application PCT/US2024/030660, filed May 22, 2024, designating the United States of America and published as International Patent Publication WO 2024/243367 A2 on Nov. 28, 2024, which claims the benefit under Article 8 of the Patent Cooperation Treaty of U.S. Patent Application Ser. No. 63/468,116, filed May 22, 2023.

### TECHNICAL FIELD

The present disclosure relates to systems and methods for carbon dioxide (CO₂) capture and separation. More specifically, to systems and methods for direct air capture of carbon dioxide, capture of carbon dioxide from a gas, capture of carbon dioxide from seawater (ocean carbon capture), and/or capture of carbon dioxide from an electrolyte solution including: (i) gaseous and/or dissolved carbon dioxide and/or (ii) carbon dioxide derived ions.

### BACKGROUND

Human activities, particularly the release of greenhouse gases, have led to significant global warming. Consequently, the Earth's surface temperature rose by 1.1 °C above the average temperature recorded between 1850 and 1900 during the period of 2011-2020. The global emission of greenhouse gases continues to escalate, predominantly due to the combustion of fossil fuels and industrial processes, primarily in the form of CO₂. This trend poses a substantial threat to human well-being and the planet's overall health. As the risks and negative impacts of climate change increase with rising global temperatures, there is an urgent need for immediate action. Implementing potential adaptation and mitigation strategies is crucial in the near future.

The burning of fossil fuels is the primary source of CO₂ emissions. This can be mitigated by gradually reducing the use of fossil fuels. While phasing out fossil fuels in the power industry and transportation sector is achievable through the adoption of renewable energy sources, certain sectors-such as steel and cement production and intercontinental air transport-currently lack feasible alternatives. Consequently, in addition to reducing emissions, it is essential to implement long-term strategies for capturing, storing, and/or utilizing CO₂.

CO₂ capture and storage (CCS) and CO₂ removal (such as Direct Air Capture with Carbon Storage (DACCS) or Carbon Dioxide Removal (CDR)) are crucial for reducing net carbon dioxide emissions. CCS typically involves capturing CO₂ emissions from centralized point sources, such as industrial processes, power generation flue gas, or vehicle exhaust. DACCS, on the other hand, focuses on removing CO₂ directly from the atmosphere. The goal of both CCS and DACCS is to sequester the captured CO₂ for long-term storage, potentially permanently, in geological formations.

According to the Intergovernmental Panel on Climate Change, to limit global warming to 1.5 °C above pre-industrial levels, it will be necessary to remove between 1.3 and 29 GtCO₂ annually from the atmosphere by 2050. While large-scale solutions for CCS are currently being implemented, DACCS technologies are still operating at a small scale due to the intrinsic complexity of the task and significant uncertainties regarding their mechanisms and costs. Therefore, there is an urgent need for new DACCS solutions and approaches to effectively address climate change within the required timeframe.

Current DACCS technologies utilize chemical processes involving capture agents such as amines or solid sorbents. These agents often require temperature and/or pressure variations to release captured CO₂ and regenerate for further use. However, these variations cause inefficiencies due to wasted energy in heating solvents and sorbents, pressurizing feed gas, or creating a vacuum for desorption. Moisture swing materials present an intriguing alternative, as they can passively absorb CO₂ without the need for heat regeneration, thereby eliminating a significant energy source. However, these materials are less effective in highly humid air conditions. Efforts to find alternative solvents with lower regeneration energy, such as methyldiethanolamine (MDEA) and potassium carbonate, have been made, but these alternatives face the challenge of slower CO₂ absorption kinetics. Additionally, technologies aimed at capturing CO₂ directly from the ocean (Direct Ocean Capture (DOC)) face challenges due to low kinetics for CO₂ hydration in the ocean as well as a lower concentration of CO₂ and related chemical species. Attempts to improve traditional membrane capacitive deionization and other electrochemical techniques have been made, but CO₂ hydration remains a limiting barrier.

To address the issue of slow kinetics, researchers have investigated materials or enzymes that can convert CO₂ from the gas phase to bicarbonates in the liquid phase through the CO₂ hydration reaction:

CO₂+H₂O↔HCO₃⁻+H⁺ [1]

The bicarbonates can subsequently be converted into carbonates according to the following reaction:

HCO₃⁻↔CO₃²⁻+H⁺ [2]

Carbonic anhydrase (CA) is a metalloenzyme that uses CO₂ as a substrate for the CO₂ hydration reaction. While CA has drawn interest for carbon capture processes, most studies have focused on its performance in homogeneous conditions when dissolved in a liquid, or in harsh conditions involving high temperatures, extreme pH, and the presence of contaminants such as heavy metals, SOx, NOx, and flue gas. These factors limit its potential.

Existing technologies for immobilizing carbonic anhydrase (CA) include immobilization on flat surfaces such as textiles and hollow-fiber membranes, as well as membranes based on solid sorbents like metal-organic frameworks and zeolites. Other approaches involve immobilization on curved surfaces such as nanoparticles and polymers or entrapment in fibers, polymers, and porous materials. Most immobilization techniques chemically bind the enzyme to the surface, which can affect protein folding and active site dynamics. Few immobilization methods ensure the conservation of CA's active site and kinetics, which are important for scaling it for DACCS applications.

Another challenge in implementing CA is the need for HCO₃⁻ and H⁺ ions to leave the enzyme's active site for efficient regeneration. The enzyme typically operates at a slightly basic pH (between 8 and 10) to facilitate proton removal. However, this does not address the accumulation of HCO₃⁻ around the enzyme, which hinders its catalytic activity. To date, no effective solution has been found to simultaneously remove both ions.

Recently, electrochemical CO₂ capture methods have garnered attention due to their potential for lower energy consumption and compatibility with renewable power sources. These methods rely on applying potential or current to capture CO₂ through pH modulation, redox-active agents, or capacitive adsorption. However, many of these methods require costly ion-selective membranes, electrode materials, and solvents. For example, electro-swing technologies use organic polymers on carbon electrodes to selectively capture CO₂ upon reduction. Although these materials exhibit high CO₂ capacity, they require additional preparation and are sensitive to oxygen, which increases maintenance costs and reduces their lifespan. Additionally, conventional charge carriers, often organic or organometallic in nature, have a poor life cycle assessment (LCA) when used in large quantities, which is common for DACCS systems. Moreover, the capture mechanism involves a chemical reaction, leading to increased energy expenditure and capture time.

Supercapacitive swing adsorption (SSA) has emerged as an attractive option for CO₂ capture due to its use of robust, cost-effective activated carbon electrodes, a separator, and an aqueous electrolyte solution for CO₂ capture and release. Capacitive techniques offer advantages over redox techniques, including longer sorbent lifetimes and high round-trip efficiency. However, to make SSA technology viable, there is a need to speed up the process and increase CO₂ adsorption capacity. Efforts to achieve this have included using thicker and/or denser electrodes with higher mass loading. Although adjusting operating voltages has increased CO₂ adsorption, so far no viable solution has been found to speed up the absorption/desorption cycles.

Thus, current devices capture only a small amount of CO₂ (μmoles) over several hours, making the overall process inefficient. The system suffers from sluggish charge transport kinetics, extremely slow sorption rates due to inefficient gas permeation, and inefficient ion formation and diffusion.

The systems and methods disclosed herein are based on identifying several critical bottlenecks in existing CO₂ capture methodologies that have yet to be adequately addressed. Specifically:
CO₂ hydration catalysts, such as carbonic anhydrase (CA), other CO₂ hydration catalysts, and CO₂ sensitive or switchable materials, often face problems with the regeneration of the enzyme and/or the substrate, leading to inefficient CO₂ capture.
CA, in particular, has been used under extreme conditions (high temperature, low pH, ion concentration fluctuations, flue gas), which hampers its efficiency.
CA immobilization techniques exist for fixing the enzyme to a surface, but questions remain regarding enzyme robustness and activity.
For the CA catalytic center to be regenerated, H⁺, HCO₃⁻, and CO₃²⁻ ions need to be rapidly withdrawn from the active site.
Supercapacitive swing adsorption is a relatively new electrochemical technique for CO₂ capture and has been tested for high CO₂ concentrations (15 vol % CO₂); however, it has several downsides, including low CO₂ intake and extremely slow operating speed due to sluggish ion dissolution and transport on the positive electrode.

The systems and methods disclosed herein not only address these bottlenecks but also optimize the integration of various components into a cohesive process to enhance overall performance, cost-effectiveness, and efficiency.

### BRIEF SUMMARY

Systems and methods for direct air capture of CO₂, and capture of CO₂ from a gas and ocean CO₂ capture, are disclosed herein. In some embodiments, one or more of these methods includes one or more of a step called air contactor/pre-concentration, a step called supercapDAC, and a step called CO₂ gas dehydration and compression. In some embodiments, CO₂ hydration catalysts, comprising one or more of CA, other CO₂ hydration catalysts, and/or any CO₂ sensitive/switchable material, may be used to accumulate one or more of gaseous CO₂, dissolved CO₂, and/or CO₂-derived ions according to reactions [1] and [2] in the presence of an electrolyte solution. In some embodiments, the electrolyte solution comprises one or more of water, water-based, or organic solvent-based solution or liquid. CO₂ sensitive/switchable material comprises substances that exhibit changes in their properties or behavior in response to the presence or concentration of carbon dioxide (CO₂) in their environment. These materials are designed to interact with CO₂ leading to detectable and often reversible alterations.

In some embodiments, the CO₂ hydration catalyst may be embedded in the air contactor, or be included in a pre-concentration step where air and/or any gas containing CO₂ is sparged through a system containing one or more of immobilized/dissolved CO₂ hydration catalysts. At least one of the air contactor and the pre-concentration step account for a step in which air/gas and electrolyte solution are contacted with a CO₂ hydration catalyst. The air contactor and/or the pre-concentration step is CO₂/HCO₃⁻/CO₃²⁻/H⁺ poor at the beginning of each cycle, and each cycle enriches the electrolyte solution inside with the aforementioned species. The electrolyte solution and air/gas may be circulated through the system. In some embodiments, the electrolyte solution may be recirculated several times within the air contactor/pre-concentration step before being sent to supercapDAC step. When the desired concentration of CO₂ in gaseous, dissolved, or ionic form is obtained, one or more of the CO₂-rich electrolyte solution may be fed to the supercapDAC.

In some embodiments, one or more of the CO₂-rich (gaseous, dissolved, or ionic form) electrolyte solution is transferred through an electrochemical device (referred to herein as supercapDAC) that, similarly to a capacitor, supercapacitor, ultracapacitor, or pseudocapacitor, and more specifically a flow capacitor or flow supercapacitor, is capable of separating the ions on the basis of their charges polarity and storing them within the electrodes' surface when a voltage bias is applied to the electrodes, where the bias can be positive or negative or 0 V (charge phase). In some embodiments, the electrode(s)′ surface may be porous. Additionally, during the charge phase, the effect of the electric double layer forming within the electrodes increases the ion storage capacity of the electrodes, where the ions can be CO₂ derived or not (including ions coming from salts dissolved in solution) and also increases the ability of the electrodes to attract and store gaseous CO₂. During the discharge phase, one or more of a voltage bias is not applied to the electrodes, a bias of 0 V is applied, or an external voltage bias is applied (either positive or negative). Gaseous CO₂, dissolved CO₂, and CO₂-derived ions desorb from the electrodes as well as the stored ions not derived from CO₂, which may recombine and thus regenerate CO₂ gas according to the inverse of reactions [1] and [2]. The electrolyte solution may be reused for multiple cycles.

In some embodiments, capacitive or supercapacitive CO₂ capture and separation may be used with a pre-concentration step in which an electrochemical device, SupercapDAC, is fed with ion-rich aqueous electrolyte solution in which CO₂ is present as gaseous CO₂, dissolved CO₂ and/or CO₂-derived ions. Because of its characteristics, similar to capacitors and supercapacitors, SupercapDAC is capable of performing ultrafast (from milliseconds to hours) charge/discharge to capture and separate CO₂ from an ion-rich electrolyte solution. Additionally, the capacitive or supercapacitive electrodes within SupercapDAC are able to attract and store one or more of gaseous CO₂, dissolved CO₂, and/or CO₂-derived ions when a voltage bias is applied, due to the effect of the electric double layer.

In some embodiments:
The CO₂ hydration catalysts can be easily regenerated, as a constant flux of electrolyte solution and air/gas are passing through a pre-concentration step.
The CO₂ hydration catalyst may be used for capture and/or release of CO₂ in its gaseous, dissolved, or ionic form.
A hybrid process comprising a device similar to a supercapacitor and more specifically a flow capacitor or flow supercapacitor, using the principles of supercapacitors and CO₂ supercapacitive swing adsorption, overcomes the main downsides of SSA. In some embodiments, a pre-concentration step ensures high concentrations of one or more of CO₂ (gaseous or dissolved), H⁺, HCO₃⁻, and/or CO₃²⁻ ions intake within the device resulting in increased operating speed (from milliseconds to hours) due to the presence of dissolved ions and fast ion transport.
The CO₂ hydration catalyst can capture CO₂ and be regenerated electrochemically or through other methods.
The electrolyte solution containing CO₂ (in its gaseous, dissolved, or ionic form) and other ions may be concentrated and/or diluted by means of forward osmosis and/or reverse osmosis or other methods producing concentrated or diluted solutions.
CO₂ may be captured and separated by incorporation into one or more of gaseous, liquid, and/or solid compounds.
CO₂ capture and separation may be modulated by modifying the ionic and/or species content (in terms of concentration and identity of species and/or ions) of the electrolyte solution.

In some embodiments:
The captured or separated CO₂ may be compressed for further utilization in one or more of chemical, physical, and/or biological processes, storage, and/or sequestration.
The captured or separated CO₂ may be vented from the capture and separation device within the electrolyte solution and degas in a dedicated chamber or degas within the device and vented through a dedicated outlet channel.
The captured and separated CO₂ may be further employed in one or more of chemical, physical, and/or biological processes without being previously compressed.
The gaseous CO₂, dissolved CO₂, or CO₂-derived ions captured in the electrolyte solution may be employed in further chemical and/or physical and/or biological processes without being separated from the electrolyte solution.

Systems and methods are disclosed herein for one of capturing and separating a target species (CO₂) from a gas or from an electrolyte solution containing CO₂ (in gaseous, dissolved, or ionic form), comprising one or more of the following steps:
Contacting a gas containing the target species with the CO₂ hydration catalyst and electrolyte solution;
Catalytically or non-catalytically (through one or more of chemical, physical, and/or biological processes) hydrating the target species thus dissolving them into an electrolyte solution, forming one or more target ions;
Separating the one or more target ions from the electrolyte solution containing CO₂ in the gas phase, dissolved phase, or in the form of CO₂-derived target ions via one or more of electric double layer formation, electrostatic interactions, and/or charge interactions by contacting the liquid with an electrochemical device;
Separating the target species (gaseous CO₂, in some embodiments) from a gas with an electrochemical device via electric double layer interaction; and
Recirculating the electrolyte solution and generating a flow of pure CO₂ gas or a flow of CO₂ gas mixed with other gases.

In some embodiments, the electrolyte solution may be a solid electrolyte or an ion exchange resin.

In some embodiments, the CO₂ hydration catalyst may be embedded within the supercapDAC unit either in solution or immobilized on a surface, which can be, but is not limited to, electrodes, separators and membranes.

Systems and methods described herein may be utilized in one or more of the following applications (among others):
CO₂ capture from any gaseous sources emitting CO₂ or containing CO₂
Direct Ocean Capture (DOC)
CO₂ from any organic-based solution containing gaseous CO₂, dissolved CO₂, and/or CO₂ in the form of target ions (H⁺, HCO₃⁻, CO₃²⁻)
CO₂ capture from any water-based solution containing gaseous CO₂, dissolved CO₂, and/or CO₂ in the form of target ions (H⁺, HCO₃⁻, CO₃²⁻)
Any gaseous and/or liquid/supercritical/solid source containing CO₂ bound physically/mechanically/chemically/electrostatically to other chemical species
Home device connecting to air ventilation systems for CO₂ capture indoors and outdoors.
Generating electrical energy from the supercapDAC
Reversibly storing electrical energy in the device supercapDAC coming, for example, from intermittent renewable energy sources
Making materials (one or more of inorganic, organic, and/or bio-derived) from the systems and methods described herein using the captured CO₂
Purifying and/or desalinating water
Wastewater purification and nutrient extraction
Making chemical precursors (acids, bases, salts, organic compounds, inorganic compounds) using the captured CO₂.
Generate and/or use heat and/or pressure from the process

The general description is provided to give a general introduction to the described subject matter as well as a synopsis of some of the technological improvements and/or advantages it provides. The general description and background are not intended to identify essential aspects of the described subject matter, nor should they be used to constrict or limit the scope of the claims. For example, the scope of the claims should not be limited based on whether the recited subject matter includes any or all aspects noted in the general description and/or addresses any of the issues noted in the background.

### BRIEF DESCRIPTION OF THE DRAWINGS

A more complete understanding of the systems, methods, processes, and apparatuses disclosed herein may be derived by referring to the detailed description when considered in connection with the accompanying illustrative figures. In the figures, like-reference numbers refer to like-elements or acts throughout the figures.

FIG. 1 depicts an embodiment of a system and method for CO₂ capture.

FIG. 2A depicts an embodiment of the operation of steps 1 (the air contactor/pre-concentration step) and 2 (the supercapDAC) during charge of the electrodes.

FIG. 2B depicts an embodiment of the operation of steps 1 and 2 during discharge of the electrodes.

FIG. 3 depicts an embodiment of a system and method for CO₂ capture.

FIG. 4 depicts an embodiment of a system and method for CO₂ capture.

FIG. 5 depicts an embodiment of a system and method for CO₂ capture.

FIGS. 6A and 6B depict the operation of an embodiment of step 1 and step 2 combined/integrated together in one single step, during charge and discharge of the electrodes, respectively.

FIG. 7 shows one embodiment of an electronic computing device 101 that may be used as part of the system for capturing a target species.

FIG. 8 shows various embodiments of the devices that can be included as part of the electronic computing device 101 in FIG. 7.

FIG. 9 shows various embodiments of the electronic computing device in FIG. 7 communicatively linked to one or more additional electronic computing devices by way of a network.

### DETAILED DESCRIPTION

Before any embodiments of the present disclosure are explained in detail, it is to be understood that the systems and methods disclosed herein are not limited in its application to the details of construction and the arrangement of components set forth in the following description or illustrated in the accompanying drawings. The systems and methods disclosed herein are capable of other embodiments and of being practiced or of being carried out in various ways. It should be noted that there are many different and alternative configurations, devices, and technologies to which the disclosed embodiments may be applied. The full scope of the embodiments is not limited to the examples that are described below.

In the following examples of the illustrated embodiments, references are made to the accompanying drawings, which form a part hereof, and in which is shown by way of illustration various embodiments in which the systems, methods, processes, and/or apparatuses disclosed herein may be practiced. It is to be understood that other embodiments may be utilized, and that structural and functional changes may be made without departing from the scope of the present disclosure.

The systems and methods described herein result in enhanced performance, costs, and efficiency of existing CO₂ capture systems. The systems and methods described herein typically comprise three steps:
Step 1: CO₂ hydration step, pre-concentration step, or air contactor step;
Step 2: supercapacitive step or supercapDAC step; and
Step 3: CO₂ dehydration and compression.

In some embodiments, the three steps are separate and distinct from each other. In some embodiments, Steps 1 and 2 may be combined into a single step.

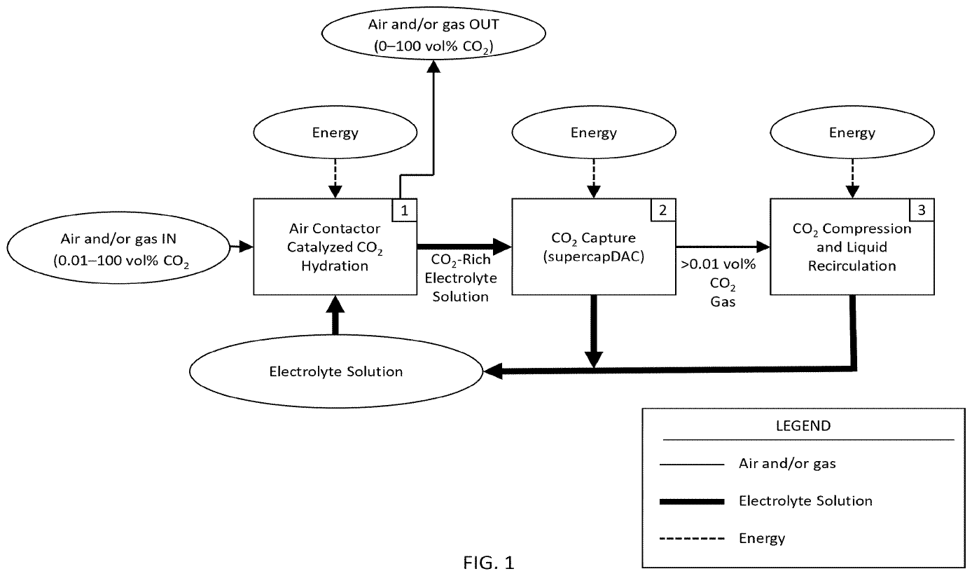

FIG. 1 depicts an embodiment of a system and method for CO₂ capture and separation. The embodiment depicted in FIG. 1 comprises three steps: Step 1 Air Contactor, Step 2 CO₂ Capture, and Step 3 CO₂ Compression.

In the depicted embodiment, Step 1, the Air Contactor, brings air/gas containing between 0.01 and 100 vol % (by volume (volume/volume or v/v)) CO₂ and an electrolyte solution (one or more of water, water-based, or organic solvent-based solution, in some embodiments) in contact with a CO₂ hydration catalyst. In Step 1, air/gas entering the Air Contactor reaches the CO₂ hydration catalyst where CO₂ derived ions are stripped and picked up by the electrolyte solution resulting in a CO₂-rich electrolyte solution that is rich in gaseous and/or dissolved CO₂ (indicated as CO₂aq) and/or CO₂⁻ derived ions (HCO₃⁻, CO₃²⁻, H⁺). The fluid is directed through specific channels to Step 2.

Step 2 is the SupercapDAC, an electrochemical device that features conductive, capacitive, porous carbon-based electrodes, in some embodiments. It can uptake the CO₂-rich (dissolved and/or gaseous and/or CO₂-derived ions) electrolyte solution stream from Step 1 and separate CO₂ (gaseous or dissolved) and the ions when a voltage bias is applied (charge phase), due to an electric double layer formation and electrostatic/covalent/non-covalent interactions. When the voltage bias is not applied or keeps being applied (discharge phase), gaseous and/or dissolved and/or CO₂-derived ions are expelled from the electrodes and thus, by recombining, they regenerate CO₂ (gas) according to the inverse of equations [1] and [2] and CO₂ (gas) desorbs and/or degasses through the device and through specific channels may be directed to Step 3. During charge, the solution stream is depleted from CO₂ and ions, and thus the electrolyte solution may be recirculated to Step 1.

### Variations to the Steps

In some embodiments, the concentration of the species [HCO₃⁻] can vary from 0.00001M to 10M. In some embodiments, the concentration of the species [CO₃²⁻] can vary from 0.00001M to 10M. In some embodiments, the concentration of the species [CO₂]aq can vary from 0.00001M to 10M. In some embodiments, the electrolyte solution contains at least one or more of HCO₃⁻, CO₃²⁻, H⁺, Al³⁺, Ca²⁺, Fe²⁺, Fe³⁺, Mg²⁺, Na⁺, K⁺, Cu²⁺, Pb²⁺, Zn²⁺, Mn²⁺, Cr³⁺, Cr⁶⁺, Ni²⁺, Cd²⁺, Ag⁺, Hg²⁺, Co²⁺, Ba²⁺, Sr²⁺, Li⁺, UO₂²⁺, Cl⁻, SO₄²⁻, NO₃⁻, HCO₃⁻, CO₃²⁻, PO₄³⁻, F⁻, Br⁻, NO₂⁻, OH⁻, I⁻, ClO₄⁻, CH₃COO⁻, CN⁻, S²⁻, SO₃²⁻, CrO₄²⁻, Cr₂O₇²⁻, ClO⁻, SCN⁻ ions in variable concentrations, ranging from 0.00001M to 10M. In some embodiments, the pH of the electrolyte solution can range within pH 4 to 13.

In some embodiments, the concentration of the species [CO₂]aq+[HCO₃⁻]+[CO₃²⁻] can be modulated by modifying the ionic and/or species content (in terms of concentration and identity of the species and/or ions) of the electrolyte solution. In some embodiments, this method comprises alkalinity modifications, pH modifications, the chemical divide concept (removing and/or adding specific ionic species to the electrolyte solution by precipitation/dissolution), by using ionic exchange resins/membranes or by employing enzymes/bacteria able to selectively absorb or release ionic species.

In some embodiments, the chemical species used for the purposes above (ions concentration modulation) are added to the electrolyte solution in Step 1 via specific channels.

In some embodiments, the chemical species used for the purposes above (ions concentration modulation) are added to the electrolyte solution between step 1 and step 2.

In some embodiments, additional ways for increasing the concentration of target ions can be used within step 1, such as evaporation (removing solvent by heating), distillation (condensing vapor to separate solvents from solutes), reverse osmosis (using a semi-permeable membrane to remove water molecules), electrodialysis (applying an electric field with ion-selective membranes), ion exchange (using ion-exchange resins to capture and elute ions), precipitation and re-dissolution (forming a precipitate and dissolving it in a smaller volume), centrifugation (spinning at high speed to separate ions based on mass and density), ultrafiltration (using a membrane with fine pores to separate ions based on size), freezing (freezing solution to crystallize pure solvent), liquid-liquid extraction (using two immiscible liquids to separate and concentrate ions), foam fractionation (generating foam to concentrate surface-active ions), electrolysis (using an electric current to collect ions at electrodes), crystallization (forming crystals from the solution), membrane filtration (using various membranes to selectively concentrate ions), adsorption (using materials like activated carbon or zeolites to adsorb and desorb ions).

In some embodiments, between Step 1 and Step 2 there is a unit that has the purpose of further concentrating the electrolyte via one or more of the following methods: Evaporation (removing solvent by heating), distillation (condensing vapor to separate solvents from solutes), reverse osmosis (using a semi-permeable membrane to remove water molecules), electrodialysis (applying an electric field with ion-selective membranes), ion exchange (using ion-exchange resins to capture and elute ions), precipitation and re-dissolution (forming a precipitate and dissolving it in a smaller volume), centrifugation (spinning at high speed to separate ions based on mass and density), ultrafiltration (using a membrane with fine pores to separate ions based on size), freezing (freezing solution to crystallize pure solvent), liquid-liquid extraction (using two immiscible liquids to separate and concentrate ions), foam fractionation (generating foam to concentrate surface-active ions), electrolysis (using an electric current to collect ions at electrodes), crystallization (forming crystals from the solution), membrane filtration (using various membranes to selectively concentrate ions), adsorption (using materials like activated carbon or zeolites to adsorb and desorb ions).

In some embodiments, the Air Contactor may be a modified cooling tower based on commercial cooling-tower technology or any other contactor design applicable (e.g., conventional contactors, crossflow columns, rotating contactors, conventional air contactor, crossflow air contactor, rotating air contactor, packed tower air contactor, spray tower air contactor, bubble column air contactor, tray tower air contactor, fluidized bed air contactor, venturi scrubber, plate column air contactor, natural draft cooling tower, mechanical draft cooling tower (induced draft cooling tower, forced draft cooling tower), crossflow cooling tower, counterflow cooling tower). In some embodiments, the air contactor comprises:
An air management unit, comprising one or more of a fan, a blower, a particle filter, or mass flow controllers through which the air flows horizontally preferentially (crossflow configuration). But could also have vertical configuration, inclined or angled configuration, modular or stacked configuration or a mix of them.
Atmospheric air or CO₂ rich air/gas (CO₂ vol % ranging from 0.01 to 100 vol %) can be used. But also other gas sources like combustion gases, fermentation processes, industrial emissions, biogas, natural gas wells, geothermal vents, photosynthesis byproduct gases, vehicle exhaust, greenhouses air, welding gas mixtures, cement production kilns emissions and/or from agricultural practices and wastewater treatment plants.
A water management unit, comprising one or more of a pump, controller(s), a water basin, and sprayer(s), tanks or vessels such as storage tanks, process vessels, pumps such as centrifugal pumps, diaphragm pumps, mixing and agitation equipment such as agitators, stirrers, filtration systems such as cartridge filters, sand filters, activated carbon filters, fiberglass filters, polyester and synthetic fiber filters, activated carbon filters, sediment filters, reverse osmosis filters, UV (ultraviolet) filters, ion exchange filters, granular activated carbon filters, ceramic filters, mechanical filters, multi-media filters, nanofiltration filters, ultrafiltration filters, microfiltration filters, ozone filters, biological filters (biofilters), chlorine filters, scale inhibitor filters, pH adjustment filters, deionization filters, heat exchangers such as shell and tube heat exchangers, plate heat exchangers, process equipment such as reactors, distillation columns, separators, instrumentation and control systems such as flow meters, temperature sensors, programmable logic controllers, safety and environmental controls such as emergency shut-off valves, pressure relief devices, chemical feed systems such as metering pumps, dosing systems, material handling and transfer equipment such as hoses, pipes, fittings, monitoring and analysis equipment such as pH meters, conductivity meters, spectrophotometers, automation and remote control systems such as SCADA systems, remote monitoring devices, UV-C germicidal irradiation, fan, blower, dampers, variable frequency drives (VFDS), nozzles or sprayers, distribution trays or fill media, pumps, control systems, particle filters, mass flow controllers, mechanical filtration (HEPA filters, ULPA filters, pleated filters), electrostatic precipitation (electrostatic air filters), ionizers and air purifiers (ionization technology, air purifiers with filters), activated carbon filtration (activated carbon filters), UV-C germicidal irradiation (UV-C air disinfection), fibrous air filters (fiberglass filters, polyester and synthetic fiber filters), portable air cleaners (portable air purifiers), natural filtration methods (plants).
Water (various kinds of water can be used: deionized water, tap water, ocean water, water-based buffer, ion-rich water, wastewaters, distilled water, demineralized water, reverse osmosis (RO) water, MCDI (membrane capacitive deionization) or CDI (capacitive deionization) water, ultrapure water, softened water, boiler feed water, cooling water, process water, high-purity water, brine, reclaimed water, sea water, condensate water, fire water, freshwater from basins, rivers, lakes, as examples) and/or organic solvent-based solutions may be constantly sprayed through the body of the air contactor. The water or organic solvent-based solutions accumulates in the basin at the bottom of the unit, in some embodiments. The bottom of the unit may be connected through pumps to the top of the unit and to Step 2 of the process. The top of the unit may be connected to Steps 2 and 3.
A porous material (alkali-metal hydroxides, metal oxides, TiO₂, SiO₂, carbon, cellulose or other derivatives, as examples):
   on which the metalloenzyme Carbonic anhydrase CA (any naturally occurring or synthetic genetic variant of carbonic anhydrase) may be immobilized (either by absorption, adsorption, surface covalent attachment, entrapment within a material or a polymer and cross-linked enzyme aggregates); and/or
   on which organometallic compounds (Zn, Ni, Cu, Co,-based) or metal-oxide nanoparticles or particles have been immobilized (either by absorption, adsorption, surface covalent attachment, entrapment within a polymer); and/or
   that acts as a CO₂ hydration catalyst (alkali-metal hydroxides, metal oxides, ionic polymer, poly-ionic liquid, polymeric amine, choline-derived ionic liquid as examples); and/or
   that acts as CO₂-sensitive/switchable material, comprising amine-functionalized polymers, metal-organic frameworks (MOFs), switchable solvents, pH-sensitive materials, smart membranes, CO₂-responsive polymers.

In some embodiments, the Air Contactor operating parameters comprise one or more of the following:
Atmospheric pressure (1 atm)
Temperature ranging between 5 °C-65 °C.
Constant relative humidity within the air contactor between 50% and 100%

In some embodiments, the pressure can vary from 0 atm to 80 atm. In some embodiments, the temperature may vary between 5 °C and 90 °C. In some embodiments, the relative humidity may vary between 0% and 100%.

In some embodiments, the porous material/substrate may be of a special architecture for optimization of the boundary layer between air, liquid, and the catalyst.

In some embodiments, depending on the type of air/gas used (CO₂ content vol % from 0.01 to 100 vol %) a filter may be applied to eliminate impurities such as particles, NOx, SOx, other oxides, heavy metals, VOCs, ozone. In some embodiments, depending on the type of electrolyte solution used, a filter may be applied to eliminate impurities such as NOx, SOx, other oxides, heavy metals, organic pollutants, particles.

In some embodiments, the CO₂ hydration catalyst benefits from the recirculation of the electrolyte solution within the air contactor to be regenerated.

In some embodiments, the CO₂ hydration catalyst is regenerated electrochemically and/or following a method for regenerating CO₂ capture materials comprising: thermal regeneration by heating the material to high temperatures; pressure swing regeneration by altering the pressure surrounding the material; vacuum regeneration by subjecting the material to a vacuum; chemical regeneration by exposing the material to a chemical agent; steam regeneration by exposing the material to steam; electrochemical regeneration by passing an electric current through the material; photothermal regeneration utilizing light energy to heat the material; and microwave regeneration by selectively heating the material with microwaves.

In some embodiments, Step 2 accounts for one or more of:
electrodes (any form of conductive carbon, activated carbon, graphitic carbon, carbon nanotubes, multiwalled carbon nanotubes, chemically functionalized carbon or any metal and alloys or other inorganic/organic conductive materials), wherein the electrodes may be bipolar carbon- or metal-based, comprising one or more of:
   capacitance;
   high porosity (micro, meso, macroporous, hierarchical porosity);
   high surface area;
   flexibility;
   thickness ranging from 1 nm to 5 m; and
   inert and/or modified (chemical modifications such as oxidation, reduction or doping, hydrophobic and/or hydrophilic treatment, covalent/non-covalent modifications with other chemical species) surface.
In some embodiments, the electrodes are connected in an electrical circuit, comprising arranging the electrodes in series, parallel, or series-parallel configurations to optimize voltage, current, or a combination thereof.
separators (cellulose or any natural or synthetic variation and/or any inert material such as ion permeable polymer-based membranes, which can be ion-selective or non-ion-selective, cation exchange membranes, anion exchange membranes, bipolar membranes, hydrophilic separators), electrolyte solution layers or channels that separate electrodes for electrolyte solution flow may have a thickness from 1 nm to 1 m, comprising one or more of:
   separator between the electrodes and/or separator between the electrodes and other elements of the device;
   electrolyte solution layers or channels between and/or through the electrodes and/or electrolyte solution layers or channels between and/or through the electrodes and other elements of the device;
   the number of electrolyte solution layers or channels between the electrodes and/or the number of electrolyte solution layers or channels between the electrodes and other elements of the device can also be zero (zero-gap configuration);
current collectors (carbon based, expanded graphite, Ti or other conductive material) with a thickness from 1 nm to 1 m, in some embodiments;
gas diffusion layers (GDL, carbon-based material, like carbon cloth, carbon paper or other porous conductive materials or polytetrafluoroethylene-based or other porous non-conductive materials) with a thickness from 1 nm to 1 m, in some embodiments;
channels with a thickness from 1 nm to 1 m, in some embodiments for the electrolyte solution flow in and out;
channels with a thickness from 1 nm to 1 m, in some embodiments for the separated gaseous CO₂ and for gas in and out, in some embodiments;
valves and regulators for the solution and the gas, so that the step can be operated in continuous or batch mode; and
pressure valves.

In some embodiments, the parameters of Step 2 comprise one or more of:
The voltage bias applied to each electrode pair is comprised between 10 and −10 V (time could vary from few hours to milliseconds, continuously and/or in pulses and/or other variations, to maximize the efficiency of the electrodes charge and discharge steps). During application of the voltage bias electrochemical reactions may happen.
The method of voltage applied to the supercapDAC may be one or more of direct, continuous, pulsed, switched, modulated sequential voltage application, individual electrode pair activation, selective voltage biasing, electrode pair-by-pair voltage application, electrode pair switching with voltage, alternating voltage application across electrode pairs, multi-electrode voltage cycling, charge-discharge cycle, pulse charging, voltage step-up/step-down, constant current charging, voltage balancing in supercapacitor banks, pulse width modulation (PWM) control, active voltage control, overvoltage protection, voltage reversal prevention.
The types of operation of the Step 2 can be one or more of pulsed, switched, modulated sequential voltage application, individual electrode pair activation, selective voltage biasing, electrode pair-by-pair voltage application, electrode pair switching with voltage, alternating voltage application across electrode pairs, multi-electrode voltage cycling, charge-discharge cycle, pulse charging, voltage step-up/step-down, constant current charging, voltage balancing in supercapacitor banks, pulse width modulation (PWM) control, active voltage control, overvoltage protection, voltage reversal prevention may be milliseconds to hours.
The architecture of Step 2 can differ: it can be stacked ore, flat, or rolled-up like a supercapacitor or any other suitable architecture (e.g., coin cell, cylindrical, prismatic, flexible hybrid form, stacked flat, rolled-up, coin cell, cylindrical, prismatic, flexible hybrid form, single cell configuration, series configuration, parallel configuration, series-parallel (hybrid) configuration, module configuration, bank configuration, integrated configuration (supercapacitor-battery hybrid)).
The electrolyte can also move through the electrodes via a flow-through configuration.
Step 2 can comprise of one supercapDAC unit or many of them stacked together (modular).
If the conductivity of the CO₂-derived ion-rich electrolyte solution is not enough, some salts (in some embodiments, preferably inorganic, such as NaCl) can be added before Step 1 and/or between Steps 1 and 2 in a concentration that ranges from 0.00001 to 10M. The ion-rich electrolyte solution could have the same composition as the water or organic solvent-based buffer used with catalysts in Step 1.
To improve performance, electrolytes and/or salts may be added to the electrolyte solution, the pH and/or temperature may be adjusted or controlled, conductive additives and/or ionic liquids may be added, solvent properties may be optimized, particle size may be controlled, and surfactants and/or additives may be utilized.
The mode of the flow of the electrolyte solution may vary during the charge and discharge steps, as it may be continuous, pulsed, or stopped completely during either step (time could vary from few hours to milliseconds).
The flow of electrolyte solution within Step 2, depending on the configuration of the device, can also be steady-state flow (continuous and uniform flow of the electrolyte through the device, often occurring under constant operating conditions), turbulent flow (chaotic, irregular flow characterized by fluctuations in velocity and pressure, common in high Reynolds number systems and can enhance mass transfer and mixing within the electrolyte), laminar flow (smooth, orderly flow characterized by parallel layers of fluid moving at different velocities, common at low Reynolds numbers and is characterized by well-defined streamlines), pulsatile flow (flow characterized by periodic variations in velocity and pressure, often due to external factors such as pumping mechanisms or pulsatile flow in biological systems), plug flow (flow where different fluid elements move at the same velocity without mixing, desirable for certain applications to minimize dispersion and maximize uniformity of reaction or separation processes), Recirculating Flow (flow where a portion of the electrolyte is diverted and recirculated back into the device, often used to enhance mixing or to control reaction kinetics), crossflow (flow where the electrolyte moves perpendicular to the direction of another flow or a surface, commonly used in membrane-based separation processes to maximize mass transfer), counterflow (flow where two fluid streams move in opposite directions, often used in heat exchangers and some separation processes to maximize efficiency), co-flow (flow where two fluid streams move in the same direction, often used in microfluidic devices and some chemical reactors to enhance mixing and reaction kinetics), regenerative flow (wherein the flow of the electrolyte solution is periodically reversed in direction to prevent fouling or to enhance mass transfer and mixing).
The electrolyte solution can be recirculated several times within Step 2.
In some embodiments, the supercapDAC is isolated from atmospheric air through one or more of encapsulation, sealing, inert atmosphere storage, hermetic sealing, so that CO₂ gas generated during discharge can be collected by generating vacuum, and thus further speeding up the inverse of reaction (1) and (2), toward CO₂ gas formation.
Vacuum generated can vary from atmospheric pressure to 10⁻⁶ Pa (high vacuum).
To selectively collect the CO₂ gas generated from step 2, one or more of degassers, vacuum chambers, gas-permeable membranes, microporous membranes, hollow fiber membranes, polymeric membranes, ceramic membranes, vacuum degassing towers, vacuum desorption units, vacuum pumps, centrifugal degassing devices, rotary evaporators, thin-film evaporators, membrane contactors, porous metal filters, hydrophobic membranes, and vacuum flash degassers may be used within step 2 or between step 2 and 3.
The composition of the gas coming out of step 2 can vary from 0 vol % to 100 vol % CO₂.
In step 2 or between step 2 and 3, there might be specific filters to capture specific gases other than CO₂.

Step 3 is a compression and water recirculation unit that may comprise one or more of:
Compressor (Multistage) Centrifugal
Pumps
Process Heater
Intercoolers
Vapor Liquid Separator Drum
Adsorption Dryer (Dehydration unit/molecular sieve dehydration)
Motor
Vacuum pump

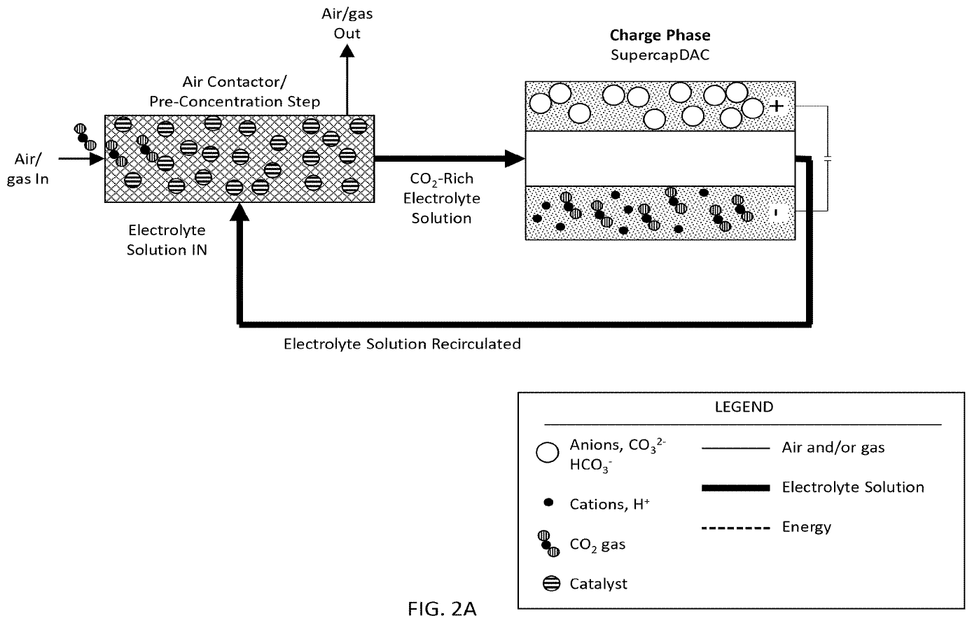

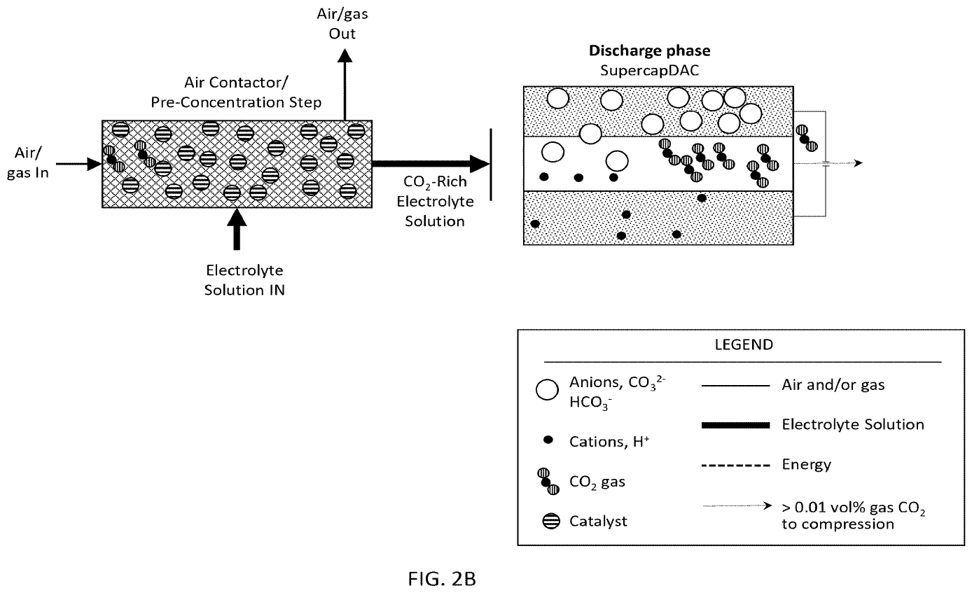

FIGS. 2A and 2B show the operation of Steps 1 and 2 during charge and discharge of the electrodes, respectively.

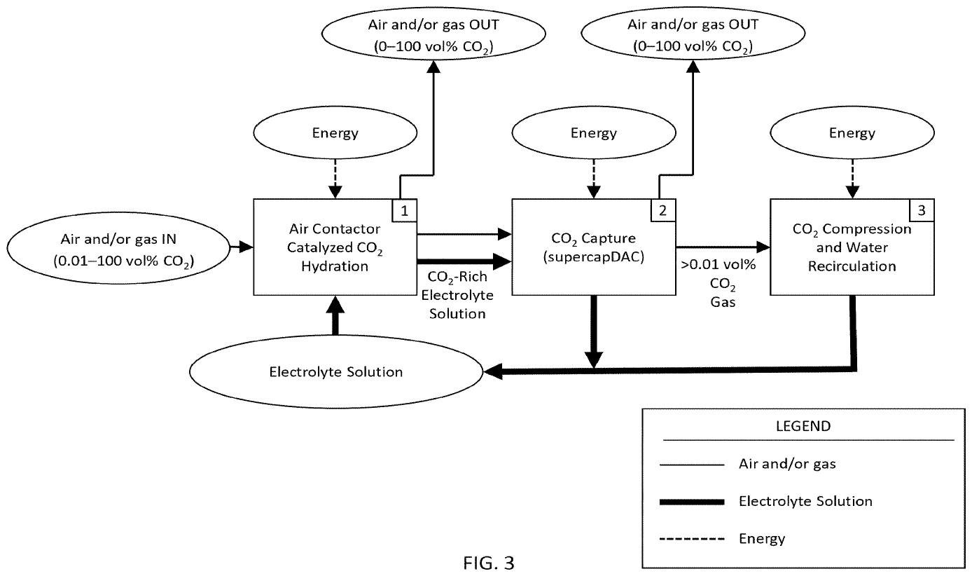

FIG. 3 depicts an embodiment of a system and method for CO₂ capture. The embodiment depicted in FIG. 3 is similar in construction and operation to the embodiment depicted in FIG. 1. To maximize CO₂ capture and leverage the electric double layer CO₂ capture, atmospheric air and/or a gas containing CO₂ may pass through the supercapDAC, as well.

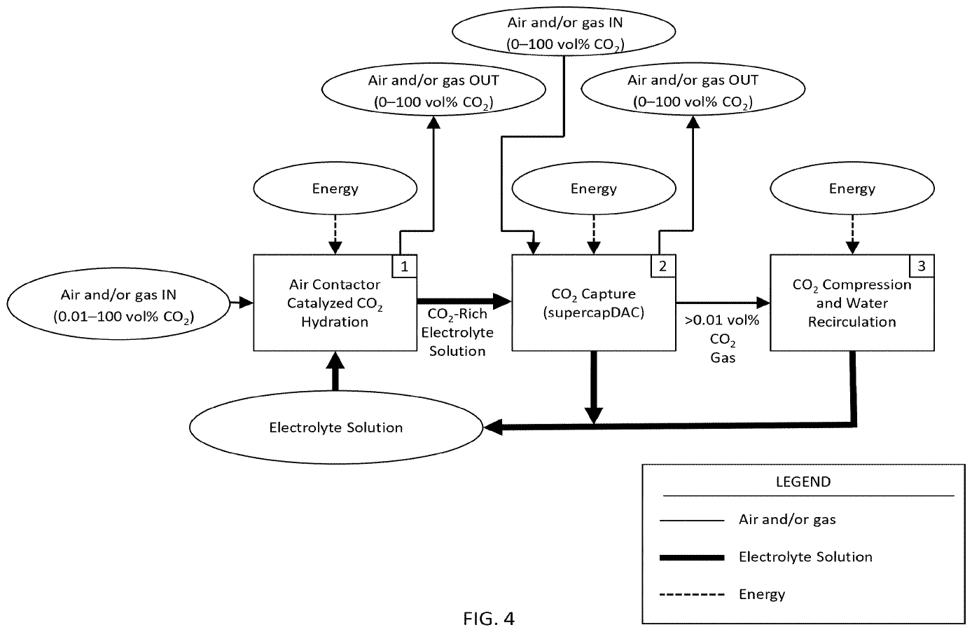

FIG. 4 depicts an embodiment of a system and method for CO₂ capture. The embodiment depicted in FIG. 4 is similar in construction and operation to the embodiment depicted in FIG. 1. To maximize CO₂ capture and leverage the electric double layer CO₂ capture, atmospheric air and/or a gas containing CO₂ passes through the supercapDAC, as well, but no air/and or gas passes from Step 1 to Step 2.

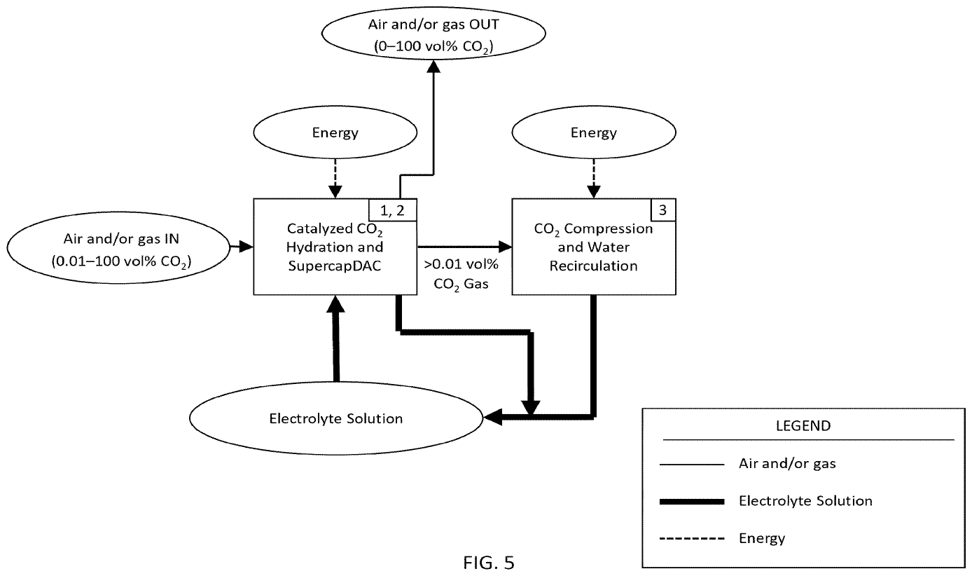

FIG. 5 depicts an embodiment of a system and method for CO₂ capture. The embodiment depicted in FIG. 5 is similar in construction and operation to the embodiment depicted in FIG. 1, but Steps 1 and 2 are fused together and the CO₂ hydration catalyst is placed and/or dissolved in the electrolyte solution between the electrodes or stacks of bipolar electrodes. This tackles the problem of CA for regeneration of the catalytic center (H⁺ and CO₃²⁻ and HCO₃⁻ ions are withdrawn very fast from the catalytic center to be able to perform another cycle).

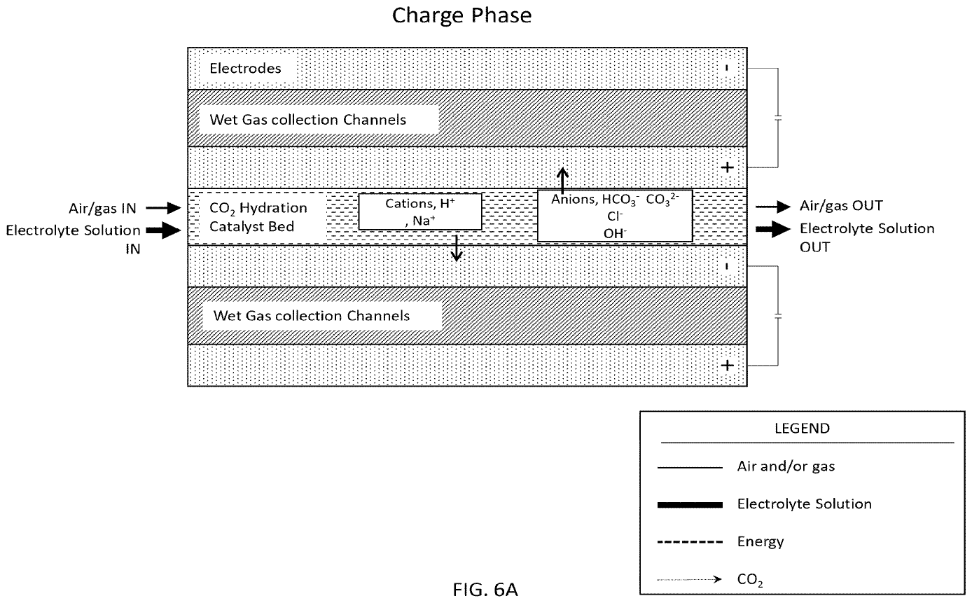

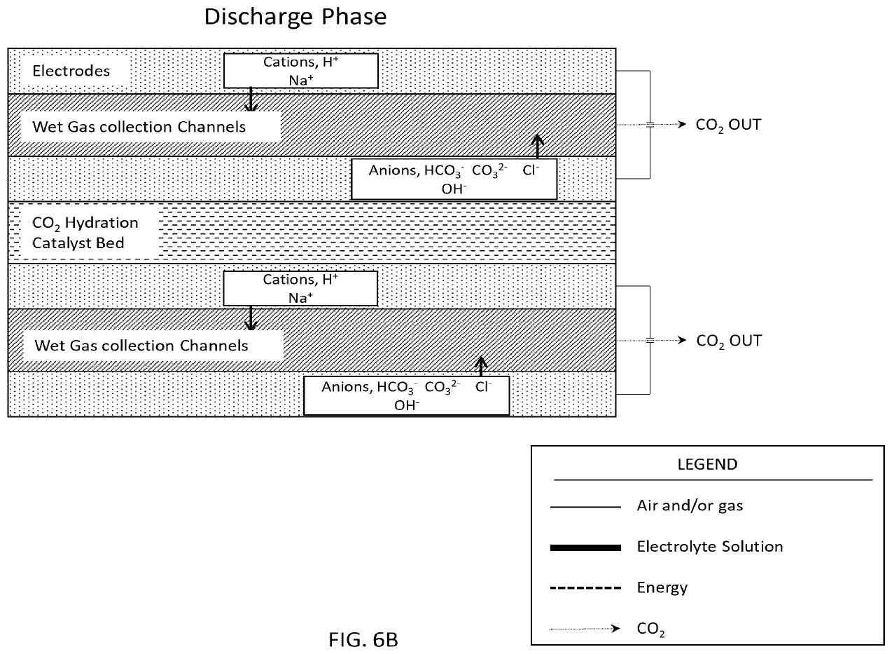

FIG. 6A depicts the operation of step 1+2 (Catalyzed CO₂ hydration+supercapDAC) during charge of the electrodes.

FIG. 6B depicts the operation of step 1+2 (Catalyzed CO₂ hydration+supercapDAC) during discharge of the electrodes.

In some embodiments, Step 2 can feature, instead of a liquid electrolyte, a solid-state electrolyte comprising one or a blend of ceramic electrolytes (e.g., lithium ceramics such as lithium oxide, lithium phosphorus oxynitride (LiPON), sulfides like lithium sulfide, garnet-type materials such as lithium lanthanum zirconate), polymer electrolytes (e.g., polyethylene oxide (PEO), polyvinylidene fluoride (PVDF), doped with lithium salts), composite electrolytes (e.g., combining ceramic particles with a polymer matrix), glass electrolytes (e.g., lithium phosphorus oxynitride glass (LiPON glass)), organic ionic liquid electrolytes (e.g., certain ionic liquids), and metal-organic frameworks (MOFs).

Step 1 and/or Step 2 can be connected in series or parallel and for Step 1 there can be one or several Step 2s connected, and vice-versa. The entire process, modular in nature, can be repeated and scaled-up indefinitely.

Additional ways to promote CO₂ Hydration reaction besides the use of CO₂ hydration catalyst:
Physical ways to hydrate CO₂, pressure modulation, temperature modulation, pH modulation, alkalinity ion content of solution (group 1, 2 transition elements+any corresponding counter-ions), stirring and bubbling, porous supports to trap CO₂, electromagnetic radiation, magnetic fields, phase changes, nanobubbles generation;
Biological ways to hydrate CO₂ including CA (any natural and/or synthetic variant), RuBisCO (any natural and/or synthetic variant), Silicases to hydrate or enhance CO₂ hydration, CO₂ hydrogenases, Carboxylases, Acetyl COA, and/or any biological process that involves photosynthesis (Photosynthetic systems, plants, algae, bacteria), carbon fixation (bacteria, example chemolithoautotrophs), respiration, carbonate/bicarbonate hydration (example marine microalgae and bacteria), carbonate formation (example corals and shells).
Active/passive air contact.
Air/gas are fed to the system either in active or in a passive way;
The active way has been described and requires electricity to power a fan and/or pumps and/or blowers within an air contactor, for example;
Passive air contact entails using wind, heat, or other moving parts to push air through the system.

Ways to obtain and transport liquids and/or gas and/or energy through the system:
System can use gravity, electricity, pressure, heat (and/or waste heat from industrial sources), electromagnetic radiation to operate.
Energy can be transported through the system by using heated liquids and/or gas, and/or solids.
System can be co-located close to a green energy source.
System can transport liquids and/or gas via pumps (by increasing or decreasing pressure) or by using gravity.

Examples of downstream possibilities (i.e., Step 2 and 3 of the process: possible ways to use the captured CO₂ and CO₂-derived ions):
CO₂ extraction & compression
Mineralization of CO₂
Formation of clathrates with wet captured CO₂
CO₂ gas conversion to supercritical and/or solid and/or liquid CO₂
CO₂ conversion to organic and/or inorganic compounds, chemicals, materials
Using bicarbonate and carbonate ions as an in-situ source of CO₂ for conversion to organic and/or inorganic compounds, chemicals, materials
Precipitation of bicarbonates and carbonates with various counter-cations

Examples of energy storage possibilities and application for the component of energy storage of the supercapDAC comprise grid energy storage, electric vehicles, industrial power management, start-stop systems in the automotive industry, regenerative braking in the automotive industry, hybrid and electric vehicles in the automotive industry, power assist systems in the automotive industry, portable electronics in consumer electronics, wearable devices in consumer electronics, power backup in consumer electronics, grid stabilization in the energy sector, renewable energy systems in the energy sector, uninterruptible power supplies (UPS) in the energy sector, power quality management in industrial applications, motor drives in industrial applications, emergency power systems in industrial applications, buses and trains in public transportation, trams and light rail in public transportation, backup power for communication towers in telecommunications, energy storage for remote installations in telecommunications, aircraft systems in aerospace and defense, military applications in aerospace and defense, portable medical equipment in medical devices, implantable devices in medical devices, energy harvesting in IoT and sensor networks, quick recharge cycles in IoT and sensor networks, energy harvesting from environmental sources in environmental and safety applications, safety systems in environmental and safety applications.

Sensor embodiments for the systems and methods.
Sensor array for detecting CO₂ flux and/or flow rate and/or concentration
Sensors for gaseous species other than CO₂ and other chemicals (N₂, O₂, NOx, SOx, other oxides, VOCs, heavy metals, particulate matter, ozone)
Sensors for water pollutants (NOx, SOx, other oxides, heavy metals, organic pollutants)
Micro and nano-sensors that can detect and track target ions (H⁺, CO₃²⁻, HCO₃⁻) and measure their movement during charge/discharge processes
Sensors for the following parameters: pressure, temperature, pH, alkalinity ion content of solution (group 1, 2 transition elements+any corresponding counter-ions), electromagnetic radiation, magnetic fields, phase changes
Biosensors for tracking biochemical processes in enzyme and/or bacteria and/or photosynthetic systems and/or plants and/or algae concentration, activity and/or robustness.
Sensors to measure the rate of CO₂ hydration reaction [1]

How data travels through the system:
Sensors may be integrated within one or more components of the system or method
Using sensors that can handle large volumes of data and provide real-time monitoring and analysis, such as Industrial Internet of Things (IIOT) devices, data loggers, or programmable logic controllers (PLCs), or similar technologies
Sensors may communicate via wired or wireless network, depending on the plant's size and requirements
Cloud-based solutions and/or on-premises servers may be used for data processing, depending on the plant's needs and security requirements

### Additional Description

The disclosed system for capturing carbon dioxide (CO₂) comprises several components and steps to efficiently capture, separate, and recycle CO₂ from various sources, including direct air capture, gas capture, and ocean CO₂ capture.

One aspect of the system involves a hydration unit configured to hydrate carbon dioxide with a CO₂ hydration catalyst. The CO₂ hydration catalyst, which can include carbonic anhydrase (CA), other CO₂ hydration catalysts, and/or CO₂ sensitive/switchable materials, interacts with the CO₂ to dissolve it into an electrolyte solution, forming CO₂-derived ions comprising H⁺, HCO₃⁻, and/or CO₃²⁻. This process involves the following reaction [1] and [2].

The electrolyte solution may include one or more of water, a water-based solution, or an organic solvent-based solution. The hydration unit may be configured with an air contactor or include a pre-concentration step where air or gas containing CO₂ is sparged through the system containing the CO₂ hydration catalyst. The air contactor and/or pre-concentration step facilitate the interaction of air/gas with the electrolyte solution, enriching the solution with CO₂-derived species. The electrolyte solution and air/gas are circulated through the hydration unit until the desired concentration of CO₂ in gaseous, dissolved, or ionic form is achieved, at which point the CO₂-rich electrolyte solution is transferred to the electrochemical device, referred to as supercapDAC.

The supercapDAC is an electrochemical device configured to separate the CO₂-derived ions from the electrolyte solution. Operating similarly to a capacitor, supercapacitor, ultracapacitor, or pseudocapacitor, flow capacitor or flow supercapacitor, supercapDAC applies a voltage bias to electrodes to form an electric double layer that separates ions based on their charge polarity and stores them within the electrodes' surfaces. The electrodes may be porous, increasing ion storage capacity and allowing for the storage of CO₂-derived ions and gaseous CO₂. During the discharge phase, the voltage bias is adjusted or removed, causing the gaseous CO₂ and CO₂-derived ions to desorb from the electrodes and regenerate CO₂ gas.

The system further includes a removal system configured to remove carbon dioxide from the electrochemical device, producing CO₂ gas. The electrolyte solution is then recirculated for additional CO₂ capture cycles.

Capacitive or supercapacitive CO₂ capture and separation may be employed with a pre-concentration step in which the electrochemical device is fed with an ion-rich aqueous electrolyte solution containing CO₂. The supercapDAC is capable of ultrafast charge/discharge cycles (from milliseconds to hours) to capture and separate CO₂. The electrodes within the supercapDAC attract and store gaseous CO₂, dissolved CO₂, and/or CO₂-derived ions when a voltage bias is applied.

The disclosed system not only addresses bottlenecks in existing CO₂ capture methodologies but also optimizes the integration of various components to enhance overall performance, cost-effectiveness, and efficiency. Key aspects of this innovation include:
Efficient hydration of CO₂ with a CO₂ hydration catalyst in an electrolyte solution.
Separation of CO₂-derived ions from the electrolyte solution using an electrochemical device.
Removal of CO₂ from the electrochemical device to produce CO₂ gas.
Recirculation of the electrolyte solution for continuous CO₂ capture.

In some embodiments, the CO₂ hydration catalyst is easily regenerated as a constant flux of electrolyte solution and air/gas passes through the pre-concentration step. The CO₂ hydration catalyst can capture CO₂ and be regenerated electrochemically or through other methods. The electrolyte solution containing CO₂ and other ions may be concentrated or diluted using forward osmosis, reverse osmosis, or other methods. CO₂ may be captured and separated into gaseous, liquid, or solid compounds, and the ionic and/or species content of the electrolyte solution can be modulated to enhance CO₂ capture and separation.

The captured or separated CO₂ can be compressed for further use in chemical, physical, or biological processes, storage, or sequestration. Alternatively, the CO₂ can be used directly without prior compression. The systems and methods can be applied in various contexts, including CO₂ capture from gaseous sources, direct ocean capture, and CO₂ capture from organic or water-based solutions. Additional applications include indoor and outdoor CO₂ capture, generating or storing electrical energy, making materials and chemical precursors, purifying water, and extracting nutrients from wastewater.

Overall, the disclosed system and method provide a comprehensive solution for capturing and separating CO₂ from various sources, significantly enhancing performance, cost-effectiveness, and efficiency.

### ILLUSTRATIVE EMBODIMENTS

The following is a description of various embodiments of the disclosed subject matter. Each embodiment may include one or more of the various features, characteristics, or advantages of the disclosed subject matter. The embodiments are intended to illustrate a few aspects of the disclosed subject matter and should not be considered a comprehensive or exhaustive description of all possible embodiments.
A1. A system and method for capturing a target species from a source, comprising one or more of: an air contactor, wherein the air contactor brings in carbon dioxide rich air or gas and water or water-based and/or organic based solution into contact with a hydration catalyst producing a water stream; a supercapDAC, comprising one or more electrodes, for receiving the water stream from the air contactor and separating carbon dioxide gas and target ions when voltage is applied, wherein when voltage is not applied carbon dioxide gas desorbs and is passed through specific channels to a compression and liquid recirculation unit; and the compression and liquid recirculation unit outputs carbon dioxide and water.
A2. The system or method of A1, wherein the target species is carbon dioxide.
A3. The system or method of any one of A1-A2, wherein the carbon dioxide rich air comprise vol % of 0.01 vol % to 100 vol %.
A4. The system or method of any one of A1-A3, wherein the water source in water/water-based solution and/or organic based used may be deionized, tap, ocean water, wastewater or other suitable water sources.
A5. The system or method of any one of A1-A4, wherein the hydration catalyst may be one of carbonic anhydrase or carbon dioxide hydration catalyst or carbon dioxide sensitive/switchable material.
A6. The system or method of A5, wherein the carbon dioxide hydration catalyst may be naturally occurring or synthetic.
A7. The system or method of A5, wherein the carbon dioxide hydration catalyst may be comprised of one or more of alkali-metal hydroxides, metal oxides, ionic polymer, poly-ionic liquid, polymeric amine, or choline-derived ionic liquid.
A8. The system or method of any one of A1-A7, wherein the carbon dioxide hydration catalyst is regenerated electrochemically.
A9. The system or method of any one of A1-A8, wherein at least one of water, water-based solution, gas, and air are continually circulated.
A10. The system or method of any one of A1-A9, wherein water or water-based solution is recirculated.
A11. The system or method of any one of A1-A10, wherein the water stream or water-based solution contains HCO₃⁻, CO₃²⁻, H⁺ ions.
A12. The system or method of any one of A1-A11, wherein the air contactor is one of conventional, crossflow, or rotating.
A13. The system or method of any one of A1-A12, wherein the air contactor comprises one or more of: an air/gas management unit; a water/water-based solution management unit; and a porous material; wherein water/water-based solution is sprayed constantly within the air contactor.
A14. The system or method of A13, wherein the air/gas management unit comprises one or more of a fan, a blower, a particle filter, or mass flow controllers.
A15. The system or method of A13, wherein flow in the air/gas management unit is horizontal.
A16. The system or method of A13, wherein the water/water-based solution management unit comprises one or more of a pump, controller, basin, and sprayers.
A17. The system or method of any one of A1-A16, wherein water/water-based solution and/or organic based accumulates in the bottom of the air contactor.
A18. The system or method of any one of A1-A17, wherein the air contactor is connected via one or more channels to supercapDAC.
A19. The system or method of any one of A1-A18, wherein the bottom of the air contactor is connected via one or more channels to supercapDAC.
A20. The system or method of A13, wherein the porous material is composed of alkali-metal hydroxides, metal oxides, TiO₂, SiO₂, carbon, and/or cellulose.
A21. The system or method of A20, wherein one or more of metalloenzyme carbonic anhydrase, organometallic compounds, metal-oxide nanoparticles or particles, is immobilized on the porous material.
A22. The system or method of A21, wherein immobilization is completed using one or more adsorption, surface covalent attachment, entrapment within a material or a polymer, or cross-linked enzyme aggregates.
A23. The system or method of any one of A21-A22, wherein organometallic compounds may be one or more of Zn, Ni, Cu, Co,-based.
A24. The system or method of any one of A1-A23, wherein the air contactor operates at atmospheric pressure.
A25. The system or method of any one of A1-A24, wherein the air contactor operates at a temperature range of 5-65 °C.
A26. The system or method of any one of A1-A25, wherein the air contactor operates with relative humidity between 50% to 100%.
A27. The system or method of any one of A1-A26, further comprising one or more water and or air filters.
A28. The system or method of any one of A1-A27, wherein the electrodes are one or more of bipolar, carbon-based, porous, conductive, ultracapacitive, high surface area, flexible, thickness from 1 nm to 1 cm.
A29. The system or method of A28, wherein the porosity is micro and/or meso and/or microporous and/or hierarchical porosity.
A30. The system or method of any one of A1-A29, wherein the electrode surfaces are inert or modified using oxidation and/or reduction and/or or doping and/or hydrophobic and/or hydrophilic treatment.
A31. The system or method of any one of A1-A30, wherein the electrodes are comprised of conductive carbon, activated carbon, graphitic carbon, carbon nanotubes, and multiwalled carbon nanotubes.
A32. The system or method of any one of A1-A31, wherein when the supercapDAC is under charge, the water stream is depleted from the ions.
A33. The system or method of any one of A1-A32, wherein the supercapDAC comprises one or more separators, current collectors, gas diffusion layers, channels for electrolyte flow, and channels for carbon dioxide gas.
A34. The system or method of A33, wherein the separators may be cellulose, natural, synthetic, or any inert material that is not permeable to ions.
A35. The system or method of any one of A33-A34, wherein channels for electrolyte flow have a thickness from 1 nm to 1 cm.
A36. The system or method of any one of A33-A35, wherein current collectors may be carbon-based, expanded graphite, titanium, or other conductive material.
A37. The system or method of any one of A33-A36, wherein the current collectors are 1 nm to 1 cm thick.
A38. The system or method of any one of A1-A37, wherein the gas diffusion layers may be a carbon-based material like carbon cloth or other porous material.
A39. The system or method of any one of A1-A38, the voltage applied in the supercapDAC is-1.4 volts to 1.4 volts.
A40. The system or method of any one of A1-A39, voltage applied to the supercapDAC may be continuous, pulsed, switched, modulated.
A41. The system or method of A40, wherein the pulse may be milliseconds to hours.
A42. The system or method of any one of A1-A41, wherein the supercapDAC is one of stacked flat, rolled-up, coin cell, cylindrical, prismatic, or flexible hybrid form.
A43. The system or method of any one of A1-A42, wherein conductivity of the ion rich water is improved using salt.
A44. The system or method of A43, wherein the salt may be inorganic.
A45. The system or method of A44, wherein the salt may be sodium chloride.
A46. The system or method of any one of A43-A45, wherein the salt concentration is 0.1M to 1.5M.
A47. The system or method of any one of A1-A46, wherein the compression and water recirculation unit comprises one or more of a compressor, pumps, process heater, intercoolers, vapor liquid separator drum, adsorption dryer, and motor.
A48. The system or method of A47, wherein the compressor is one or multi-stage or centrifugal.
A49. The system or method of any one of A47-A48, wherein the adsorption dryer is one of dehydration unit or molecular sieve dehydration.
A50. The system or method of any one of A1-A49, further comprising the step of: passing air/gas from the air contactor through the supercapDAC.
A51. The system or method of any one of A1-A50, further comprising the step of: passing air/gas through the supercapDAC.
A52. The system or method of any one of A1-A51, wherein the air contactor and supercapDAC are combined.
A53. The system or method of any one of A1-A52, wherein the hydration catalyst is sandwiched between stacks of two or more bipolar electrodes.
A54. The system or method of any one of A1-A53, wherein the sources comprises at least one of gaseous sources emitting carbon dioxide, ocean, any organic-based solution containing gaseous carbon dioxide and/or carbon dioxide in the form of target ions (H⁺, HCO₃⁻, CO₃²⁻), any water-based solution containing gaseous carbon dioxide and/or carbon dioxide in the form of target ions (H⁺, HCO₃⁻, CO₃²⁻), any gaseous and/or liquid/supercritical/solid source containing carbon dioxide bound physically/mechanically/chemically/electrostatically to other chemical species, home device connecting to air ventilation systems for carbon dioxide capture indoors and outdoors, making electrical energy from the supercapDAC, storing electrical energy in the device supercapDAC, making materials (inorganic and/or organic and/or bio-derived) from the system using the captured carbon dioxide, purifying and/or desalinating water, wastewater purification and nutrient extraction, chemical precursors (acids, bases, salts, organic compounds, inorganic compounds).
A55. The system or method of any one of A1-A54, further comprising a pre-concentration step wherein the source containing the target species is sparged through a system comprising immobilized/dissolved CA and/or other carbon dioxide hydration catalyst and/or any carbon dioxide sensitive/switchable material.
A56. The system or method of any one of A1-A55, wherein when the desired concentration of ions is obtained, the ion-rich water or water-based solution is fed to the supercapDAC.
A57. The system or method of any one of A1-A56, wherein during the charge phase, the effect of the electric double layer forming within the electrodes increases ion storage and increases the ability of the electrodes to attract and store gaseous carbon dioxide (Electric double layer carbon dioxide capture).
A58. The system or method of any one of A1-A57, wherein supercapacitive electrodes within supercapDAC are able to attract and store gaseous carbon dioxide when a voltage is applied, due to the effect of the electric double layer (Electric double layer carbon dioxide capture).
A59. The system or method of any one of A1-A58, wherein the conditions for DAC and/or carbon dioxide capture are not extreme (high temperature, low/high pH, ion concentration fluctuations, flue gas) and ensuring minimal CA degradation.
A60. The system or method of any one of A1-A59, wherein the pre-concentration step ensures high carbon dioxide gas and/or H⁺ and/or HCO₃⁻ and/or CO₃²⁻ ions intake within the device.
A61. The system or method of any one of A1-A60, wherein the target species is in the gas phase.
A62. The system or method of any one of A1-A61, wherein the ion-rich water or water-based solution has the same composition as the water-based buffer used with catalysts in the air contacting step.
A63. The system or method of any one of A1-A62, wherein carbon dioxide hydration may occur using one or more of: physical ways to hydrate carbon dioxide, pressure modulation, temperature modulation, pH modulation, alkalinity ion content of solution (group 1, 2 transition elements+any corresponding counter-ions), stirring and bubbling, porous supports to trap carbon dioxide, electromagnetic radiation, magnetic fields, phase changes; or biological ways to hydrate carbon dioxide including CA (any natural and/or synthetic variant), RuBisCO (any natural and/or synthetic variant), Silicases to hydrate or enhance carbon dioxide hydration, carbon dioxide hydrogenases, Carboxylases, Acetyl COA, and/or any biological process that involves photosynthesis (Photosynthetic systems, plants, algae, bacteria), carbon fixation (bacteria, example chemolithoautotrophs), respiration, carbonate/bicarbonate hydration (example marine microalgae and bacteria), carbonate formation (example corals and shells).
A64. The system or method of any one of A1-A63, wherein air/gas are fed to the system using one of an active or passive method.
A65. The system or method of A64, wherein the active method requires electricity to power a fan and/or pumps and/or blowers within an air contactor.
A66. The system or method of any one of A64-A65, wherein the passive method uses wind, heat, or other moving parts to push air through the system.
A67. The system or method of any one of A1-A66, wherein transportation of one or more of liquids, gas, and energy through the system comprises one or more of: using gravity, electricity, heat (and/or waste heat from industrial sources), electromagnetic radiation to operate; using heated liquids and/or gas, and/or solids; co-locating system in proximity to a green energy source; using pumps (by increasing or decreasing pressure).
A68. The system or method of any one of A1-A67, wherein the captured carbon dioxide may be used for one or more of carbon dioxide extraction & compression, mineralization of carbon dioxide, formation of clathrates, carbon dioxide gas conversion to supercritical and/or solid and/or liquid, carbon dioxide, or carbon dioxide conversion to organic and/or inorganic compounds, chemicals, materials.
A69. The system or method of any one of A1-A68, further comprising one or more sensors.
A70. The system or method of A69, wherein the sensors comprise one or more of: sensor array for detecting carbon dioxide flux and/or concentration; sensors for gaseous species other than carbon dioxide (NOx, SOx, other oxides, VOCs, heavy metals, particulate matter, ozone); sensors for water pollutants (NOx, SOx, other oxides, heavy metals, organic pollutants); micro and nano-sensors capable of detecting and tracking one or more target ions (H⁺, CO₃²⁻, HCO₃⁻) and measuring their movement during charge/discharge processes; one or more of pressure, temperature, pH, alkalinity ion content of solution, electromagnetic radiation, magnetic fields, phase change sensors; biosensors; and rate or reaction rate sensors.
A71. The system and method of any one of A1-A70, wherein data may be transferred through the system using one or more of: sensors integrated within one or more components of the system; systems that handle large volumes of data and provide real-time monitoring and analysis, such as Industrial Internet of Things (IIoT) devices, data loggers, or programmable logic controllers (PLCs), or similar technologies; sensors communicate via wired or wireless network; cloud-based solutions and/or on-premises servers for data processing.
A72. A system and method for capturing a target species from a gas or water-based liquid, comprising: contacting a gas containing the target species with a carbon dioxide hydration catalyst (a capture material) and water; catalytically or non-catalytically hydrating the target species thus dissolving them into water or water-based solution, forming target ions; separating the target ions from a water-based liquid containing carbon dioxide in the form of ions by contacting the liquid with an electrochemical device via electric double layer formation and electrostatic interactions and charge interactions; separating the target species (carbon dioxide) from a gas with an electrochemical device via electric double layer interaction; and recirculating the water used and generating a flow of pure carbon dioxide gas.
A73. The system or method of A72, wherein the target species is carbon dioxide.
A74. The system or method of any one of A72-A73, wherein the system comprises one or more sensors.
B1. A method comprising: hydrating carbon dioxide with a carbon dioxide hydration catalyst to dissolve the carbon dioxide into an electrolyte solution and thereby form CO₂-derived ions comprising H⁺, HCO₃⁻, and/or CO₃²⁻; separating the CO₂-derived ions from the electrolyte solution with an electrochemical device; removing carbon dioxide from the electrochemical device to produce carbon dioxide gas; and recirculating the electrolyte solution for further carbon dioxide capture.
B2. The method of B1, wherein the carbon dioxide hydration catalyst comprises carbonic anhydrase.
B3. The method of B2, wherein the carbonic anhydrase is immobilized on a surface.
B4. The method of any one of B1-B3, wherein the electrolyte solution comprises one or more of water, a water-based solution, or an organic solvent-based solution.
B5. The method of any one of B1-B4, wherein hydrating the carbon dioxide comprises sparging air or gas containing carbon dioxide through the electrolyte solution with the carbon dioxide hydration catalyst.
B6. The method of any one of B1-B5, wherein the electrochemical device is a supercapacitor, an ultracapacitor, a pseudocapacitor, a flow capacitor or flow supercapacitor or a hybrid of the above.
B7. The method of B6, wherein the electrochemical device operates by applying a voltage bias to electrodes to form an electric double layer that increases ion storage capacity.
B8. The method of any one of B1-B7, wherein the electrochemical device comprises porous electrodes.
B9. The method of any one of B1-B8, wherein the removed carbon dioxide gas is compressed for further utilization.
B10. The method of any one of B1-B9, where the removed carbon dioxide gas is utilized without being previously compressed in one or more of chemical, physical, and/or biological processes.
B11. The method of any one of B1-B10, where the CO₂-derived ions in the electrolyte solution are used in further chemical, physical, and/or biological processes without being separated from the electrolyte solution.
B12. The method of any one of B1-B11, further comprising modulating carbon dioxide hydration by altering the ionic and/or species content of the electrolyte solution.
B13. The method of any one of B1-B12, further comprising purifying or desalinating a water-based solution using the electrochemical device.
B14. The method of any one of B1-B13, wherein the electrochemical device generates or stores electrical energy during the method.
B15. A system for capturing carbon dioxide comprising: a hydration unit configured to hydrate carbon dioxide with a carbon dioxide hydration catalyst and dissolve the carbon dioxide into an electrolyte solution and form CO₂-derived ions comprising H⁺, HCO₃⁻, and/or CO₃²⁻; an electrochemical device configured to separate the CO₂-derived ions from the electrolyte solution; a removal system configured to remove carbon dioxide from the electrochemical device to produce carbon dioxide gas; and a recirculation system configured to recirculate the electrolyte solution for further carbon dioxide capture.
B16. A method comprising: hydrating carbon dioxide with a carbon dioxide hydration catalyst to dissolve the carbon dioxide into a solution and thereby form CO₂-derived ions comprising H⁺, HCO₃⁻, and/or CO₃²⁻; separating the CO₂-derived ions from the solution with an electrochemical device and an electrolyte; and removing carbon dioxide from the electrochemical device to produce carbon dioxide gas.
B17. The method of B16, wherein the electrolyte is a solid electrolyte.
B18. A system and method for capturing, separating, and concentrating a target species from a source, comprising one or more of: an air contactor, wherein the air contactor brings in air, CO₂-rich air or gas and water or water-based or organic solvent-based solution into contact with a CO₂-hydration catalyst producing an electrolyte solution stream; a supercapDAC, comprising one or more electrodes, for receiving the electrolyte solution stream from the air contactor and separating CO₂ gas, dissolved CO₂ and target ions when voltage is applied, wherein when voltage is applied or not applied CO₂ gas, dissolved CO₂ and target ions desorb and are passed through specific channels to a compression and liquid recirculation unit; and the compression and liquid recirculation unit outputs CO₂, which can be mixed with other gases or not and an electrolyte solution and a purified solution.
B19. The system or method of B18, wherein the target species is CO₂ or other gases such as CO, CH₄, SO₂, NO, NO₂ or other relevant gases.
B20. The system or method of any one of B18-B19, wherein the CO₂ rich air comprise CO₂ vol % of 0.01 vol % to 100 vol %.
B21. The system or method of any one of B18-B20, wherein the water source in water/water-based solution used may be deionized, tap, ocean water, wastewater or other suitable water sources.
B22. The system or method of any one of B18-B21, wherein the hydration catalyst may be one of carbonic anhydrase or CO₂ hydration catalyst or CO₂ sensitive/switchable material.
B23. The system or method of B22, wherein the CO₂ hydration catalyst may be naturally occurring or synthetic.
B24. The system or method of any one of B22-B23, wherein the CO₂ hydration catalyst may be comprised of one or more of alkali-metal hydroxides, metal oxides, ionic polymer, poly-ionic liquid, polymeric amine, or choline-derived ionic liquid.
B25. The system or method of any one of B18-B24, wherein the CO₂ hydration catalyst is regenerated electrochemically.
B26. The system or method of any one of B18-B25, wherein one or more of water, water-based solution, organic solvent-based solution, gas, air, CO₂-rich air are continually circulated.
B27. The system or method of any one of B18-B26, wherein water or water-based or organic solvent-based solution is recirculated.
B28. The system or method of any one of B18-B27, wherein the water stream or water-based or organic solvent-based solution contains at least one or more of HCO₃⁻, CO₃²⁻, H⁺, Al³⁺, Ca²⁺, Fe²⁺, Fe³⁺, Mg²⁺, Na⁺, K⁺, Cu²⁺, Pb²⁺, Zn²⁺, Mn²⁺, Cr³⁺, Cr⁶⁺, Ni²⁺, Cd²⁺, Ag⁺, Hg²⁺, Co²⁺, Ba²⁺, Sr²⁺, Li⁺, UO₂²⁺, Cl⁻, SO₄²⁻, NO₃⁻, HCO₃⁻, CO₃²⁻, PO₄³⁻, F⁻, Br⁻, NO₂⁻, OH⁻, I⁻, ClO₄⁻, CH₃COO⁻, CN⁻, S²⁻, SO₃²⁻, CrO₄²⁻, Cr₂O₇²⁻, ClO⁻, SCN⁻ ions.
B29. The system or method of any one of B18-B28, wherein the air contactor is one of conventional air contactor, crossflow air contactor, rotating air contactor, packed tower air contactor, spray tower air contactor, bubble column air contactor, tray tower air contactor, fluidized bed air contactor, venturi scrubber, plate column air contactor, natural draft cooling tower, mechanical draft cooling tower (induced draft cooling tower, forced draft cooling tower), crossflow cooling tower, counterflow cooling tower.
B30. The system or method of any one of B18-B29, wherein the air contactor comprises one or more of: an air/gas management unit; a water/water-based/organic solvent-based solution management unit; and a porous material; wherein water/water-based/organic solvent-based solution is sprayed constantly within the air contactor.
B31. The system or method of B30, wherein the air/gas management unit comprises one or more of a fan, blower, dampers, variable frequency drives (VFDS), nozzles or sprayers, distribution trays or fill media, pumps, control systems, particle filters, mass flow controllers, mechanical filtration (HEPA filters, ULPA filters, pleated filters), electrostatic precipitation (electrostatic air filters), ionizers and air purifiers (ionization technology, air purifiers with filters), activated carbon filtration (activated carbon filters), UV-C germicidal irradiation (UV-C air disinfection), fibrous air filters (fiberglass filters, polyester and synthetic fiber filters), portable air cleaners (portable air purifiers), natural filtration methods (plants).
B32. The system or method of any one of B30-B31, wherein flow in the air/gas management unit is horizontal configuration, vertical configuration, inclined or angled configuration, modular or stacked configuration or a mix of them.
B33. The system or method of any one of B30-B32, wherein the water/water-based/organic solvent-based solution management unit comprises one or more of tanks or vessels such as storage tanks, process vessels, pumps such as centrifugal pumps, diaphragm pumps, mixing and agitation equipment such as agitators, stirrers, filtration systems such as cartridge filters, sand filters, activated carbon filters, fiberglass filters, polyester and synthetic fiber filters, activated carbon filters, sediment filters, reverse osmosis filters, UV (ultraviolet) filters, ion exchange filters, granular activated carbon filters, ceramic filters, mechanical filters, multi-media filters, nanofiltration filters, ultrafiltration filters, microfiltration filters, ozone filters, biological filters (biofilters), chlorine filters, scale inhibitor filters, pH adjustment filters, deionization filters, heat exchangers such as shell and tube heat exchangers, plate heat exchangers, process equipment such as reactors, distillation columns, separators, instrumentation and control systems such as flow meters, temperature sensors, PLCs, safety and environmental controls such as emergency shut-off valves, pressure relief devices, chemical feed systems such as metering pumps, dosing systems, material handling and transfer equipment such as hoses, pipes, fittings, monitoring and analysis equipment such as pH meters, conductivity meters, spectrophotometers, automation and remote control systems such as SCADA systems, remote monitoring devices, UV-C germicidal irradiation.
B34. The system or method of any one of B18-B33, wherein water/water-based/organic solvent-based solution accumulates and recirculates in the air contactor.
B35. The system or method of any one of B18-B34, wherein the air contactor is connected via one or more channels to supercapDAC.
B36. The system or method of any one of B18-B35, wherein the bottom of the air contactor is connected via one or more channels to supercapDAC.
B37. The system or method of B30, wherein the porous material is composed of alkali-metal hydroxides, metal oxides, TiO₂, SiO₂, carbon, cellulose, and other organic and/or inorganic materials.
B38. The system or method of B37, wherein one or more of metalloenzyme carbonic anhydrase, organometallic compounds, metal-oxide nanoparticles or particles, is immobilized on the porous material.
B39. The system or method of B38, wherein immobilization is completed using one or more adsorption, surface covalent attachment, entrapment within a material or a polymer, or cross-linked enzyme aggregates.
B40. The system or method of any one of B38-B39, wherein organometallic compounds may be one or more of Zn, Ni, Cu, Co,-based.
B41. The system or method of any one of B18-B40, wherein the air contactor operates at atmospheric pressure.
B42. The system or method of any one of B18-B41, wherein the air contactor operates at a temperature range of 5-90 °C.
B43. The system or method of any one of B18-B42, wherein the air contactor operates with relative humidity between 50% to 100%.
B44. The system or method of any one of B18-B43, further comprising one or more water/solution and/or air filters.
B45. The system or method of any one of B18-B44, wherein the electrodes are one or more of bipolar, carbon-based or metal-based or other organic/inorganic material, porous, conductive, ultracapacitive, high surface area, flexible, thickness from 1 nm to 100 cm.
B46. The system or method of B45, wherein the porosity is macro and/or meso and/or microporous and/or hierarchical porosity.
B47. The system or method of any one of B18-B46, wherein the electrode surfaces are inert or modified using oxidation and/or reduction and/or or doping and/or hydrophobic and/or hydrophilic treatment and/or covalent or non-covalent attachment of other chemical species.
B48. The system or method of any one of B18-B47, wherein the electrodes are comprised of conductive carbon, activated carbon, graphitic carbon, carbon nanotubes, multiwalled carbon nanotubes, metal, alloys, inorganic or organic conductive materials, or a combination of the above.
B49. The system or method of any one of B18-B48, wherein when the supercapDAC is under charge, the electrolyte solution stream is depleted from the ions, which can be CO₂-derived or not.
B50. The system or method of any one of B18-B49, wherein the supercapDAC comprises one or more separators, current collectors, gas diffusion layers, channels for electrolyte solution flow, and channels for CO₂ gas.
B51. The system or method of B50, wherein the separators may be cellulose, natural, synthetic, or any inert material such as polymer-based separators, ion permeable polymer-based membranes, which can be ion-selective or non-ion-selective, cation exchange membranes, anion exchange membranes, bipolar membranes, hydrophilic separators.
B52. The system or method of any one of B50-B51, wherein channels for electrolyte flow have a thickness from 1 nm to 100 cm.
B53. The system or method of any one of B50-B52, wherein current collectors may be carbon-based, expanded graphite, titanium, or other conductive material.
B54. The system or method of any one of B50-B53, wherein the current collectors are 1 nm to 1 m thick.
B55. The system or method of any one of B18-B54, wherein the gas diffusion layers may be carbon-based material, like carbon cloth, carbon paper or other porous conductive materials or polytetrafluoroethylene-based or other porous non-conductive materials and it may have a thickness from 1 nm to 1 m.
B56. The system or method of any one of B18-B55, the voltage bias applied in the supercapDAC is between 1.4 and −1.4 volts per electrode pair.
B57. The system or method of any one of B18-B56, the voltage bias applied in the supercapDAC is between 10 and −10 volts per electrode pair.
B58. The system or method of any one of B18-B57, where the method of voltage applied to the supercapDAC may be direct, continuous, pulsed, switched, modulated sequential voltage application, individual electrode pair activation, selective voltage biasing, electrode pair-by-pair voltage application, electrode pair switching with voltage, alternating voltage application across electrode pairs, multi-electrode voltage cycling, charge-discharge cycle, pulse charging, voltage step-up/step-down, constant current charging, voltage balancing in supercapacitor banks, pulse width modulation (PWM) control, active voltage control, overvoltage protection, voltage reversal prevention.
B59. The system or method of any one of B18-B58, wherein the pulsed, switched, modulated sequential voltage application, individual electrode pair activation, selective voltage biasing, electrode pair-by-pair voltage application, electrode pair switching with voltage, alternating voltage application across electrode pairs, multi-electrode voltage cycling, charge-discharge cycle, pulse charging, voltage step-up/step-down, constant current charging, voltage balancing in supercapacitor banks, pulse width modulation (PWM) control, active voltage control, overvoltage protection, voltage reversal prevention may be applied for a time range spanning from milliseconds to hours.
B60. The system or method of any one of B18-B59, wherein the supercapDAC is one or more of stacked flat, rolled-up, coin cell, cylindrical, prismatic, flexible hybrid form, single cell configuration, series configuration, parallel configuration, series-parallel (hybrid) configuration, module configuration, bank configuration, integrated configuration (supercapacitor-battery hybrid).
B61. The system or method of any one of B18-B60, wherein conductivity of the ion rich water is improved adding electrolytes, salts, increasing ion concentration, adjusting pH, temperature control, using conductive additives, applying electric fields (electrolysis), utilizing ionic liquids, optimizing solvent properties, particle size control, using surfactants or additives.
B62. The system or method of B61, wherein the salt, acid or base may be organic and/or inorganic.
B63. The system or method of B62, wherein the salt may be sodium chloride.
B64. The system or method of B61, wherein the salt concentration is 0.000001M-5M.
B65. The system or method of any one of B18-B64, wherein the compression and water recirculation unit comprises one or more of a compressor, pumps, process heater, intercoolers, vapor liquid separator drum, adsorption dryer, and motor.
B66. The system or method of B65, wherein the compressor is one or multi-stage or centrifugal.
B67. The system or method of any one of B65-B66, wherein the adsorption dryer is one of dehydration unit or molecular sieve dehydration.
B68. The system or method of any one of B18-B67, further comprising the step of: passing air/gas from the air contactor through the supercapDAC.
B69. The system or method of any one of B18-B68, further comprising the step of: passing air/gas through the supercapDAC.
B70. The system or method of any one of B18-B69, wherein the air contactor and supercapDAC are combined and integrated in a single unit.
B71. The system or method of any one of B18-B70, wherein the hydration catalyst is placed and/or immobilized and/or dissolved and/or suspended between stacks of two or more electrodes.
B72. The system or method of any one of B18-B71, wherein the sources comprises at least one of gaseous sources emitting CO₂, atmospheric air, ocean water, seawater, freshwater, water sources like rivers, lakes, ponds, streams, reservoirs, and groundwater, any organic-based solution containing gaseous CO₂ and/or dissolved CO₂ and/or CO₂ in the form of target ions (H⁺, HCO₃⁻, CO₃²⁻), any water-based solution containing gaseous CO₂ and/or dissolved CO₂ and/or CO₂ in the form of target ions (H⁺, HCO₃⁻, CO₃²⁻), any gaseous and/or liquid/supercritical/solid source containing CO₂ bound physically/mechanically/chemically/electrostatically to other chemical species, home device connecting to air ventilation systems for CO₂ capture indoors and outdoors, generating electrical energy from the supercapDAC, storing electrical energy in the device supercapDAC, making materials (inorganic and/or organic and/or bio-derived) from the system using the captured CO₂, purifying and/or desalinating water, wastewater purification and nutrient extraction, chemical precursors (acids, bases, salts, organic compounds, inorganic compounds).
B73. The system or method of any one of B18-B72, further comprising a pre-concentration step wherein the source containing the target species is sparged through a system comprising immobilized/dissolved/suspended carbonic anhydrase and/or other CO₂ hydration catalyst and/or any CO₂ sensitive/switchable material.
B74. The system or method of any one of B18-B73, wherein when the desired concentration of CO₂ in the electrolyte solution is obtained in the form of gaseous CO₂ or dissolved CO₂ or CO₂-derived ions, the CO₂-rich water or water-based or organic solvent-based solution is fed to the supercapDAC.
B75. The system or method of any one of B18-B74, wherein during the charge phase, the effect of the electric double layer forming within the electrodes increases ion storage and increases the ability of the electrodes to attract and store gaseous CO₂, dissolved CO₂ or CO₂-derived ions (Electric double layer CO₂ capture).
B76. The system or method of any one of B18-B75, wherein capacitive and/or supercapacitive and/or pseudocapacitive electrodes within supercapDAC are able to attract and store gaseous CO₂, dissolved CO₂ or CO₂-derived ions when a voltage is applied.
B77. The system or method of any one of B18-B76, wherein the pre-concentration step ensures high gaseous CO₂, dissolved CO₂ and/or CO₂-derived ions (H⁺, HCO₃⁻ and/or CO₃²⁻) intake within the device.
B78. The system or method of any one of B18-B77, wherein the target species is in the gas phase and/or in the rich water or water-based or organic solvent-based solution.
B79. The system or method of any one of B18-B78, wherein the ion-rich water or water-based or organic solvent-based solution has the same composition as the water-based buffer used with catalysts in the air contacting step.
B80. The system or method of any one of B18-B79, wherein the ion-rich water or water-based or organic solvent-based solution has a different composition than the water-based buffer used with catalysts in the air contacting step.
B81. The system or method of any one of B18-B80, wherein CO₂ hydration may occur using one or more of: physical ways to hydrate CO₂, pressure modulation, temperature modulation, pH modulation, alkalinity ion content of solution modulation (group 1, 2 transition elements+any corresponding counter-ions), stirring and bubbling, porous supports to trap CO₂, electromagnetic radiation, magnetic fields, phase changes; or biological ways to hydrate CO₂ including carbonic anhydrase (any natural and/or synthetic variant), RuBisCO (any natural and/or synthetic variant), silicases to hydrate or enhance CO₂ hydration, CO₂ hydrogenases, carboxylases, acetyl CoA, and/or any biological process that involves photosynthesis (photosynthetic systems, plants, algae, bacteria), carbon fixation (bacteria, example chemolithoautotrophs), respiration, carbonate/bicarbonate hydration (example marine microalgae and bacteria), carbonate formation (example corals and shells).
B82. The system or method of any one of B18-B81, wherein air/gas are fed to the system using one of an active or passive method.
B83. The system or method of B82, wherein the active method requires electricity to power a fan and/or pumps and/or blowers within an air contactor.
B84. The system or method of B83, wherein the passive method uses wind, heat, or other moving parts to push air through the system.
B85. The system or method of any one of B18-B84, wherein transportation of one or more of liquids, gas, and energy through the system comprises one or more of: using gravity, electricity, pressure, heat (and/or waste heat from industrial sources), electromagnetic radiation to operate; using heated liquids and/or gas, and/or solids; co-locating system in proximity to a green energy source; and using pumps (by increasing or decreasing pressure).
B86. The system or method of any one of B18-B85, wherein the captured CO₂ may be used for one or more of CO₂ extraction and compression, mineralization of CO₂, formation of clathrates, CO₂ gas conversion to supercritical and/or solid and/or liquid, CO₂, or CO₂ conversion to organic and/or inorganic compounds, chemicals, materials, using bicarbonate and carbonate ions as an in situ source of CO₂ for conversion to organic and/or inorganic compounds, chemicals, materials, precipitation of bicarbonates and carbonates with various counter-cations.
B87. The system or method of any one of B18-B86, further comprising one or more sensors.
B88. The system or method of B87, wherein the sensors comprise one or more of: sensor array for detecting CO₂ flux and/or concentration; sensors for gaseous species other than CO₂ and other chemical species (N₂, O₂, NOx, SOx, other oxides, VOCs, heavy metals, particulate matter, ozone); sensors for water pollutants (NOx, SOx, other oxides, heavy metals, organic pollutants); micro and nano-sensors capable of detecting and tracking one or more target ions (H⁺, CO₃²⁻, HCO₃⁻) and measuring their movement during charge/discharge processes; one or more of pressure, temperature, pH, conductivity, alkalinity ion content of solution, electromagnetic radiation, magnetic fields, phase change sensors; biosensors; and rate or reaction rate sensors.
B89. The system and method of any one of B18-B88, wherein data may be transferred through the system using one or more of: sensors integrated within one or more components of the system; systems that handle large volumes of data and provide real-time monitoring and analysis, such as Industrial Internet of Things (IIOT) devices, data loggers, or programmable logic controllers (PLCs), or similar technologies; sensors communicate via wired or wireless network; and cloud-based solutions and/or on-premises servers for data processing.
B90. The system and method of any one of B18-B89, wherein the one or more electrodes are connected in an electrical circuit.
B91. The system and method of any one of B18-B90, wherein the electrolyte solution stream flows through the supercapDAC as a steady-state flow or turbulent flow.
B92. The system and method of any one of B18-B91, wherein the supercapDAC is isolated from atmospheric air.
B93. The system and method of any one of B18-B92, wherein the separated CO₂ from the supercapDAC is collected with one or more degassers, vacuum chambers, gas-permeable membranes, microporous membranes, hollow fiber membranes, polymeric membranes, ceramic membranes, vacuum degassing towers, vacuum desorption units, vacuum pumps, centrifugal degassing devices, rotary evaporators, thin-film evaporators, membrane contactors, porous metal filters, hydrophobic membranes, or vacuum flash degassers.
B94. The system and method of any one of B18-B93, wherein the concentration of one or more of the species [CO₂]aq+[HCO₃⁻]+[CO₃²⁻] can be modulated by modifying the ionic and/or species content (in terms of concentration and identity of the species and/or ions) of the electrolyte solution.
B95. The system and method of B94, wherein the chemical species used for ions concentration modulation can be added to the electrolyte solution via specific channels.
B96. The system and method of any one of B94-B95, wherein the chemical species used for ions concentration modulation can be added to the electrolyte solution between step 1 and step 2.
B97. The system and method of any one of B94-B96, wherein the concentration of target ions can be increased at step 1.
B98. The system and method of any one of B18-B97, wherein there is a unit between step 1 and step 2 that has the purpose of further concentrating the electrolyte.
B99. The system and method of any one of B18-B98, comprising valves and/or regulators for the solution and/or the gas, so that the step can be operated in continuous or batch mode.
B100. The system and method of any one of B18-B99, wherein the air/gas can be fed to the system either in active or in a passive way.
B101. A system and method for capturing a target species from a gas or water-based or organic solvent-based liquid, comprising: contacting a gas containing the target species with a CO₂ hydration catalyst (a capture material) and water; catalytically or non-catalytically hydrating the target species thus dissolving them into water or water-based solution, forming target ions; separating the target ions from a water-based liquid containing CO₂ in the form of gaseous CO₂, dissolved CO₂ and CO₂-derived ions by contacting the liquid with an electrochemical device via electric double layer formation and electrostatic interactions and charge interactions; separating the target species (CO₂) from a gas with an electrochemical device via electric double layer interaction; and recirculating the water used and generating a flow of pure CO₂ gas or CO₂ mixtures with other gases.
B102. The system or method of B101, wherein the target species is CO₂.
B103. The system or method of any one of B101-B102, wherein the system comprises one or more sensors.

### Electronic Computing Device

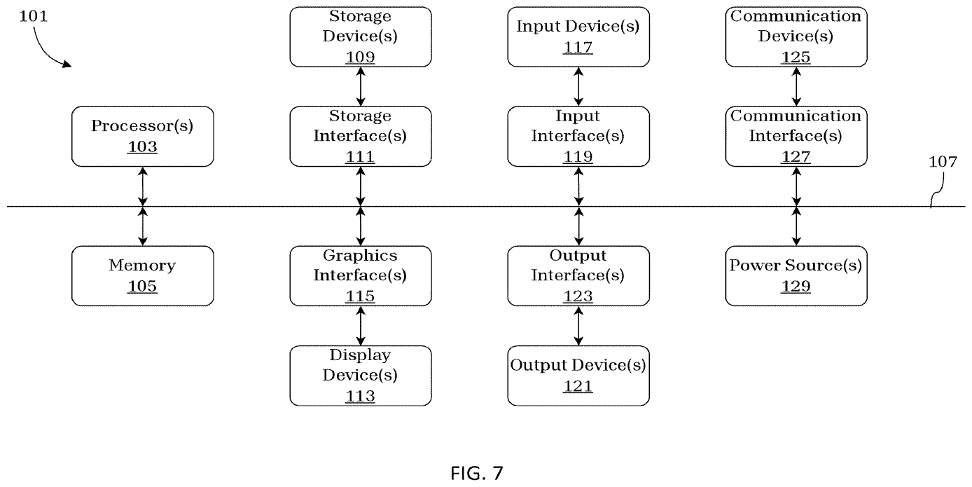

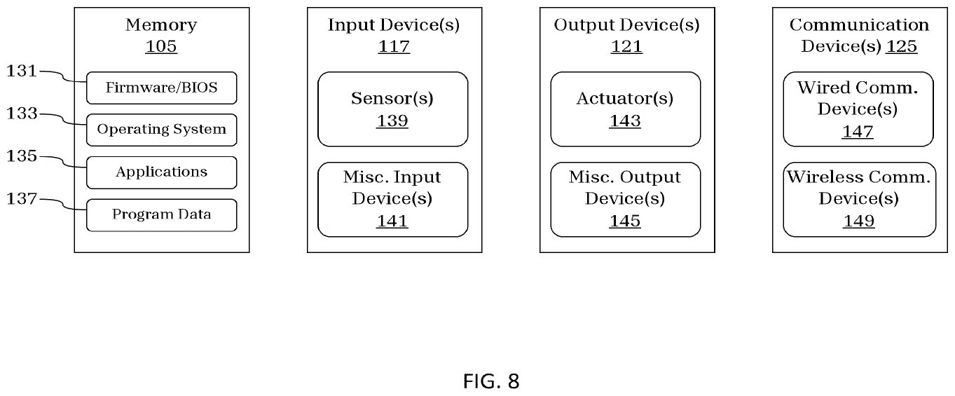

FIG. 7 shows one embodiment of an electronic computing device 101 (alternatively referred to as an electronic controller, programmable logic controller, electronic control system, or electronic computing system) that can be part of the system. The electronic computing device 101 can be used to control the system in any of the ways described above. FIG. 8 shows embodiments of the devices that can be included as part of the electronic computing device 101.

The electronic computing device 101 includes one or more processors 103 (alternatively referred to as a digital processing unit or microprocessor) and memory 105 communicatively linked to each other by way of a system bus 107. In some embodiments, the electronic computing device 101 can also include one or more other interfaces and/or devices communicatively linked to the system bus 107.

For example, one or more storage devices 109 can be communicatively linked to the system bus 107 by way of one or more storage interfaces 111. One or more display devices 113 can be communicatively linked to the system bus 107 by way of one or more graphics interfaces 115. One or more input devices 117 can be communicatively linked to the system bus 107 by way of one or more input interfaces 119. One or more output devices 121 can be communicatively linked to the system bus 107 by way of one or more output interfaces 123. One or more communication devices 125 can be communicatively linked to the system bus 107 by way of one or more communication interfaces 127.

It should be appreciated that the electronic computing device 101 can have a variety of configurations. For example, in some embodiments, the various components of the electronic computing device 101 can be positioned near each other in one or more housings and on a single circuit board or multiple circuit boards communicatively linked together, or the like. In other embodiments, the various components of the electronic computing device 101 can be located remotely. For example, the one or more input devices 117 and/or the one or more output devices 121 can be located remotely or at a distance from the one or more processors 103 and/or the memory 105.

### Processor

Each of the one or more processors 103 is an electric circuit such as an integrated circuit that executes program instructions. The processor 103 can perform operations such as arithmetic operations, logic operations, controlling operations, and input/output (I/O) operations specified by the program instructions. In some embodiments, the processor 103 includes a control unit (CU), an arithmetic logic unit (ALU), and/or a memory unit (alternatively referred to as cache memory).

The control unit can direct the operation of the processor 103 and/or instruct the memory 105, arithmetic logic unit, and output devices 121 how to respond to instructions in the program. It can also direct the flow of data or information between the processor 103 and other components of the electronic computing device 101. It can also control the operation of other components by providing timing and control signals.

The arithmetic logic unit is an electric circuit in the processor 103 that performs integer arithmetic and bitwise logic operations. The arithmetic logic unit receives input in the form of data or information to be operated on and code describing the operation to be performed. The arithmetic logic unit provides the result of the performed operation as output. In some configurations, the arithmetic logic unit can also include status inputs and/or outputs that convey information about a previous operation or the current operation between the arithmetic logic unit and external status registers.

It should be appreciated that the processor 103 can have any suitable configuration. For example, the processor 103 can range from a simple processor specially built or configured to execute one or more programs for a specific application or device to a complex central processing unit configured to be used in a wide variety of ways and an equally wide variety of applications. Examples of processors 103 include a general-purpose processor, a digital signal processor (DSP), an application specific integrated circuit (ASIC), a central processing unit (CPU), a field programmable gate array (FPGA) or other programmable logic device (PLD), and/or discrete gate or transistor logic. The processor 103 can also be implemented as any one or combination of these devices.

### Memory

The memory 105 (alternatively referred to as primary memory, main memory, or a computer-readable medium) is a semiconductor device or system used to store information for immediate use by the processor 103. The memory 105 is generally directly accessible to the processor 103. The processor 103 can read and execute program instructions stored in the memory 105 as well as store data and/or other information in the memory 105 that is actively being operated on. The memory 105 is generally more expensive and operates at higher speeds compared to the storage device 109. The memory 105 can be volatile such as random-access memory (RAM) or non-volatile such as read-only memory (ROM).

### System Bus

The system bus 107 broadly refers to the communication system through which information is transferred between the processor 103, the memory 105, and/or other components such as peripherals that can be considered part of the electronic computing device 101. The system bus 107 can include a physical system of connectors, conductive pathways, optical pathways, wires, or the like through which information travels.

The system bus 107 can have a variety of physical configurations. In some embodiments, the system bus can be configured as a backbone connecting the processor 103, the memory 105, and/or the various devices and/or interfaces as shown in the figure. In other embodiments, the system bus 107 can be configured as separate buses that communicatively link one or more components together. For example, the system bus 107 can include a bus communicatively linking the processor 103, the memory 105, and/or circuit board (the bus can alternatively be referred to as the front-side bus, memory bus, local bus, or host bus). The system bus 107 can include multiple additional I/O buses communicatively linking the various other devices and/or interfaces to the processor 103.

It should be appreciated that information shared between the components of the electronic computing device 101 can include program instructions, data, signals such as control signals, commands, bits, symbols, or the like. The information can be represented using a variety of different technologies and techniques. For example, in some embodiments, the information can be represented by voltages, currents, electromagnetic waves, magnetic fields or particles, optical fields, or the like.

The system bus 107 can also be used for other purposes besides sharing information. For example, the system bus 107 can be used to supply power from the power source 129 to the various devices and/or interfaces connected to the system bus 107. Likewise, the system bus 107 can include address lines that match those of the processor 103. This allows information to be sent to or from specific memory locations in the memory 105. The system bus 107 can also provide a system clock signal to synchronize the various devices and/or interfaces with the rest of the system.

The system bus 107 can use a variety of architectures, communication protocols, or protocol suites to communicatively link the processor 103, the memory 105, and/or any of the other devices and/or interfaces. For example, suitable architectures include Industry Standard Architecture (ISA), Extended Industry Standard Architecture (EISA), Micro Channel Architecture (MCA), Video Electronics Standards Association (VESA), Peripheral Component Interconnect (PCI), PCI Express (PCI-X), Personal Computer Memory Card Industry Association (PCMCIA or PC bus), Accelerated Graphics Port (AGP), Small Computer Systems Interface (SCSI), and the like. Suitable communication protocols include TCP/IP, IPX/SPX, Modbus, DNP, BACnet, ControlNet, Ethernet/IP, or the like.

### Program Instructions

The instructions stored in the electronic computing device 101 can include software algorithms and/or application programs. It should be appreciated that the software algorithms can be expressed in the form of methods or processes performed in part or entirely by the electronic computing device 101 or as instructions stored in a computer-readable medium such as the memory 105 and/or the storage device 109. Likewise, the software algorithms are shown in the flowcharts and described in the methods and/or processes.

It should be appreciated that instructions can take the form of entirely software (including firmware, resident software, micro-code, or the like), entirely hardware, or a combination of software and hardware. If implemented in software executed by the processor 103, the information may be stored on or transmitted over a computer-readable medium such as the memory 105 and/or the storage device 109. In some embodiments, the instructions can be contained in any tangible medium of expression having program code embodied in the medium. In some embodiments, the instructions can be written in any combination of one or more programming languages, which can be text-based or graphical languages.

It should also be appreciated that the flowcharts, block diagrams, methods, and/or processes describe algorithms and/or symbolic representations of information operations. The algorithmic descriptions and representations are the means used by those skilled in the data processing arts to convey the substance of their work most effectively to others skilled in the art. These operations, while described functionally or logically, are understood to be implemented by software and/or hardware that can be readily and easily created from the functional or logical descriptions of the algorithms.

For example, the instructions can include an algorithm for making a decision—e.g., determining whether a parameter satisfies one or more conditions and performing various operations based upon the parameter satisfying the one or more conditions. This can be represented in the instructions with a conditional statement or condition expression written in a programming language. An example of such a conditional is shown below. It should be appreciated that the syntax for the conditional will vary depending on the chosen programming language.

```
if condition1satisfied then
  perform operation 1
elseif condition2satisfied then
  perform operation 2
elseif condition3satisfied then
  perform operation 3
else
  perform operation 4;
end if;
```

The instructions can be used to perform a variety of operations. For example, the instructions can be used to control the receipt and processing of data from the input devices 117. The instructions can also be used to control hardware such as any of the output devices 121.

In some embodiments, the instructions can include firmware such as a basic input/output system (BIOS) 131, an operating system 133, one or more application programs 135, program data 137, and the like. These can be stored in the memory 105 and/or the storage device 109. In general, the instructions are stored in the memory 105 when the electronic computing device 101 is on and running or while the instructions are being used (e.g., an application program is running). Likewise, the instructions are stored in the storage device 109 when the electronic computing device 101 is off.

In some embodiments, the instructions are used to control the system in the manner described herein.

### Storage Device

Each of the one or more storage devices 109 (alternatively referred to as secondary memory, or a computer-readable medium) is a device or system used to store information that is not needed for immediate use by the processor 103. The storage device 109 can be communicatively linked to the system bus 107 by way of a storage interface 111. The storage device 109 is generally not directly accessible to the processor 103. The storage device 109 is generally less expensive and operates at lower speeds compared to the memory 105. The storage device 109 is also generally non-volatile and used to permanently store the information.

The storage device 109 can take a variety of physical forms and use a variety of storage technologies. For example, in some embodiments, the storage device 109 can be in the form of a hard disk storage device, solid-state storage device, optical storage device, or the like. Also, in some embodiments, the storage device 109 can use technologies such as a magnetic disk (e.g., disk drives), laser beam (e.g., optical drives), semiconductor (e.g., solid-state drives), and/or magnetic tape to store information.

### Display Device

Each of the one or more display devices 113 (alternatively referred to as a human-machine interfaces (HMI) or screens) is a device that visually conveys text, graphics, video, and/or other information. In some embodiments, the information shown on the display device 113 exists electronically and is displayed for a temporary period of time. It should be appreciated that the display device 113 can operate as an output device and/or input device (e.g., touchscreen display or the like).

The display device 113 can be communicatively linked to the system bus 107 by way of one or more graphics interfaces 115. In some embodiments, the graphics interface 115 can be used to generate a feed of output images to the display device 113. In some embodiments, the graphics interface 115 can be a separate component such as a dedicated graphics card or chip or can be an integrated component that is part of or a subset of the processor 103.

It should be appreciated that the display device 113 can include a variety of physical structures and/or display technologies. For example, in some embodiments, the display device 113 can be a screen integrated into a specific application or technology, a separate screen such as a monitor, or the like. The display device 113 can also be a liquid crystal display, a light emitting diode display, a plasma display, a quantum dot display, or the like.

### Input Devices

Each of the one or more input devices 117 is a physical component that provides information to the processor 103 and/or the memory 105. The input device 117 can be communicatively linked to the system bus 107 by way of one or more input interfaces 119. The input device 117 can be any suitable type and can provide any of a variety of information. For example, the input device 117 can be a digital and/or analog device and can provide information in a digital or analog format. Also, the input device 117 can be used to provide user input for controlling the electronic computing device 101 or operational input for controlling aspects of a specific application.

The input device 117 can include one or more sensors 139 and/or one or more other miscellaneous input devices 141. It should be appreciated that the input device 117 is not limited to only providing information. In some embodiments, the input device 117 can also receive information. Such devices can be considered both an input device 117 and an output device 121.

The miscellaneous input device 141 can include a variety of devices or components. In some embodiments, the miscellaneous input devices 141 can include switches such as limit switches, level switches, vacuum switches, pressure switches, or the like, as well as buttons including pushbuttons or the like. In some embodiments, the miscellaneous input devices 141 include user interface components such as a pointing device, for example, a mouse, text input devices, for example, a keyboard, a touch screen, or the like.

### Sensors

Each of the one or more sensors 139 can be used to provide information about a wide variety of measured parameters. In general terms, the sensor 139 is used to measure or detect information about its environment and send the information to the processor 103 and/or the memory 105. In some embodiments, the sensor 139 can operate as a transducer and generate an electrical signal as a function of the measured parameter. The electrical signal is communicated to the processor 103 and/or the memory 105 where it can be used for a variety of purposes.

The sensor 139 can be a digital sensor and/or an analog sensor. For example, in some embodiments, the sensor 139 provides digital information to the processor 103 and/or the memory 105. In other embodiments, the sensor 139 provides analog information to the processor 103 and/or the memory 105. Also, in some embodiments, the information can be converted from one type to the other—e.g., from digital to analog or from analog to digital.

The sensor 139 can measure the parameter directly (i.e., direct measurement) or indirectly (i.e., indirect measurement). A direct measurement sensor directly measures the parameter itself. An indirect measurement sensor measures a secondary parameter that can be translated into the parameter of interest.

The sensor 139 can communicate information to the processor 103 and/or the memory 105 in a variety of ways and/or using a variety of protocols. In some embodiments, the sensor 139 can be a protocol-based sensor that uses a protocol to communicate with the processor 103 and/or the memory 105, or it can be a nonprotocol-based sensor that does not use a protocol to communicate with the processor 103 and/or the memory 105. A protocol-based sensor communicates with the processor 103 by sending a data stream by way of a communication protocol. In some embodiments, the protocol-based sensor includes a separate processor that is part of the sensor and used to communicate using the protocol.

It should be appreciated that the information provided by the sensor 139 can be used in a variety of ways by the processor 103. For example, in some embodiments, the processor 103 can compare the information to a set point. In some embodiments, analog information is amplified before being compared to the set point.

In some embodiments, the sensor 139 can be used to measure one or more parameters. For example, the sensors 139 can be used to measure flow rates, temperature, positions, and the like.

### Temperature Sensors

In some embodiments, the sensor 139 is a temperature sensor used to measure the temperature associated with the process. Temperature is the physical quantity expressing the thermal energy present in matter. In some embodiments, the temperature sensor acts as a transducer and generates an electrical signal as a function of the measured temperature.

The temperature sensor can be a contact type temperature sensor or a non-contact type temperature sensor. Contact type temperature sensors are positioned in physical contact with the material and rely primarily on conduction to detect changes in its temperature. Non-contact type temperature sensors are not positioned in physical contact with the material and rely primarily on convection and/or radiation to detect changes in its temperature.

The temperature sensor can be any of a variety of types of temperature sensors. For example, suitable temperature sensors include thermocouples (type K, J, T, E, N, S, R, or the like), resistance temperature detectors (RTDs), thermistors, bimetallic strips, semiconductor temperature sensors, thermometers, vibrating wire temperature sensors, infrared temperature sensors, or the like.

### Pressure Sensors

In some embodiments, the sensor 139 is a pressure sensor used to measure the pressure of fluids such as pneumatic and/or hydraulic fluids. Pressure is an expression of the force required to stop the fluid from expanding and is expressed in force per unit area. In some embodiments, the pressure sensor acts as a transducer and generates an electrical signal as a function of the measured pressure.

The pressure sensor can be configured to measure a variety of pressures. In some embodiments, the pressure sensor is an absolute pressure sensor configured to measure the pressure relative to a vacuum. In some embodiments, the pressure sensor is a gauge pressure sensor configured to measure the pressure relative to ambient atmospheric pressure. In some embodiments, the pressure sensor is a differential pressure sensor configured to measure the difference between two pressures. In some embodiments, the pressure sensor is a sealed pressure sensor configure to measure the pressure relative to some fixed pressure other than ambient atmospheric pressure.

The pressure sensor can use a variety of pressure sensing technologies. In some embodiments, the pressure sensor can use force collecting pressure sensing technology. These types of electronic pressure sensors use a force collector such as a diaphragm, piston, bourdon tube, bellows, or the like, to measure strain or deflection due to applied force over an area. Examples of suitable force collector pressure sensors includes piezoresistive strain gauge pressure sensors, capacitive pressure sensors, electromagnetic pressure sensors, piezoelectric pressure sensors, strain-gauge pressure sensors, optical pressure sensors, potentiometric pressure sensors, force balancing pressure sensors, or the like. In some embodiments, the pressure sensor can use other properties such as density to infer pressure of a fluid.

### Position Sensors

In some embodiments, the sensor 139 is a position sensor configured to measure the position of system components such as valves and the like. The position sensor can be used to determine the absolute position or location of the component or the relative position or displacement of the component in terms of linear travel, rotational angle, or three-dimensional space. In some embodiments, the position sensor acts as a transducer and generates an electrical signal as a function of the measured position.

The position sensor can be a contact type position sensor or a non-contact type position sensor. Contact type position sensors are positioned in physical contact with the component to detect changes in its position. Non-contact type position sensors can detect changes in the position of the component without being in physical contact with it.

The position sensor can be any of a variety of types of position sensors and can be used to measure a variety of positions or movements including linear, rotary, and/or angular positions or movements. For example, suitable position sensors include potentiometric position sensors, inductive position sensors such as a linear variable differential transformer or a rotary variable differential transformer, eddy current-based position sensors, capacitive position sensors, magnetostrictive position sensors, hall effect-based magnetic position sensors, fiber optic position sensors, optical position sensors, ultrasonic position sensors, or the like.

### Light Sensors

In some embodiments, the sensor 139 is a light sensor configured to measure various aspects of the system and/or method. The light sensor can be used to determine the presence and/or intensity of light by measuring the radiant energy that exists in a certain range of frequencies, which typically include the infrared, visible, and/or ultraviolet light spectrum. In some embodiments, the light sensor acts as a transducer and generates an electrical signal as a function of the measured radiant energy.

The light sensor can include a variety of different light sensing technologies. In some embodiments, the light sensor generates electricity when illuminated. Examples of such light sensors include photovoltaic light sensors and photo-emissive light sensors. In some embodiments, the light sensor changes its electrical properties when illuminated. Examples of such light sensors include photoresistor light sensors and photoconductor light sensors.

### Image Sensors

In some embodiments, the sensor 139 is an image sensor used to create an image of an aspect of the system and/or method. In general, an image sensor is a device that detects and conveys information used to make an image. The image sensor converts the variable attenuation of radiation waves (infrared, visible, and/or ultraviolet spectrum radiation as well as other frequencies) into signals that convey the information.

The image sensor can be any of a variety of types of image sensors. For example, suitable image sensors include electronic image sensors such as a charge-coupled device (CCD), active-pixel sensor (CMOS sensor), or the like. The image sensor can be part of a camera or other imaging device.

### Output Devices

Each of the one or more output devices 121 is a physical component that receives information from the processor 103 and/or the memory 105. The output device 121 can be communicatively linked to the system bus 107 by way of one or more output interfaces 123. The output device 121 can be any suitable type and can receive any of a variety of information. For example, the output device 121 can be a digital and/or analog device and can receive information in a digital and/or analog format. Also, the output device 121 can be used to provide information to the user or perform various operations related to the specific application.

The output device 121 can include one or more actuators 143 and/or one or more other miscellaneous output devices 145. It should be appreciated that the output device 121 is not limited to only receiving information. In some embodiments, the output device 121 can also send information. Such devices can be considered both an output device 121 and an input device 117.

The miscellaneous output devices 145 can include a variety of devices or components. In some embodiments, the miscellaneous output devices 145 can include audio output devices such as speakers as well as other output devices.

### Actuators

Each of the one or more actuators 143 can be used to activate movement or an operation. In general terms, the actuator 143 is used to activate something in response to an instruction or control signal sent from the processor 103. In some embodiments, the actuator 143 can act as a transducer by receiving an electrical signal and transforming it into the desired movement or operation.

The information received by the actuator 143 can take a variety of forms and use a number of technologies. For example, the information may be in the form of an electric voltage or current, pneumatic or hydraulic fluid pressure, binary data, or the like. The information can be provided as digital and/or analog format. For example, in some embodiments, the actuator 143 receives digital information from the processor 103 or other component(s) in the electronic computing device 101. In other embodiments, the actuator 143 receives analog information from the processor 103 or other component(s) in the electronic computing device 101. Also, in some embodiments, the information received by the actuator 143 can be converted from one type to the other—e.g., from digital to analog or from analog to digital.

The actuator 143 can use a variety of energy sources to operate. For example, the actuator 143 can operate using electrical energy, hydraulic energy, pneumatic energy, thermal energy, magnetic energy, or the like. Likewise, the actuator 143 can be an electric actuator, hydraulic actuator, pneumatic actuator, thermal actuator, magnetic actuator, or the like. The actuator 143 can also be used to produce a variety of movements. For example, the actuator 143 can be used to produce linear movement and/or rotary movement.

### Motors

In some embodiments, the actuator 143 can include an electric motor. In general, the electric motor is a device that converts electrical energy to mechanical energy. In some embodiments, the mechanical energy produced by the electric motor is in the form of the rotation of a shaft. The mechanical energy can be used directly or converted into other mechanical movement using levers, gears, ratchets, cams, or the like. The motor can be a DC motor or an AC motor.

### Relays

In some embodiments, the actuator 143 can include a relay. In general, a relay is an electrically operated switch. In some embodiments, the relay includes one or more input terminals to receive information or control signals and one or more operating contact terminals electrically linked to a separate electrical device.

In some embodiments, the relays can include electromechanical relays having contacts that mechanically open and close. For example, the relay can include an electromagnet that opens and closes the contacts. In other embodiments, the relays can include solid state relays that use semiconductor properties to control the on or off state of the relay without any moving parts. Solid state relays can include thyristors and transistors to switch currents up to a hundred amps or more.

### Communication Devices

Each of the communication devices 125 is a physical component that allows the electronic computing device 101 to communicate with other devices, components, and/or networks. The communication device can be communicatively linked to the system bus 107 by way of one or more communication interfaces 127. The communication device 125 can include one or more wired communication devices 147 and/or one or more wireless communication devices 149.

It should be appreciated that the communication device 125 can be any suitable physical device. For example, in some embodiments, the communication device 125 is a network interface controller used to connect the electronic computing device 101 to a larger network such as a local area network (LAN), wide area network (WAN), or the Internet.

It should also be appreciated that the communication device 125 can use a variety of communication protocols. For example, in some embodiments, the wired communication device 147 can use communication protocols such as ETHERNET®, RS-232, RS-485, USB, or the like. Also, in some embodiments, the wireless communication devices 149 can use communication protocols such as Wi-Fi®, BLUETOOTH®, Zigbee®, LTE®, 5G, or the like.

### Power Source

The power source 129 can be used to supply electric power to the electronic computing device 101. The power source 129 can provide any suitable type of power including AC power, DC power, or the like. The power source 129 can obtain power from any suitable source including an AC power source (standard wall outlet), DC power source (a transformer plugged into a wall outlet), battery, generator, or the like.

In some embodiments, the power source 129 includes a power supply that converts electric current from a source to a desired voltage, current, and/or frequency to power the electronic computing device 101. In some embodiments, the power supply can convert AC power ranging from 110-240 VAC to DC power ranging from 6-60 VDC.

### Circuit Board

The electronic computing device 101 can include one or more circuit boards (alternatively referred to as logic boards) to which one or more of the components can be coupled. For example, the processor 103, the memory 105, the storage device 109, the display device 113, the input device 117, the output device 121, the communication device 125, and/or the power source 129 can be coupled to one or more circuit boards. In some embodiments, the processor 103, the memory 105, and/or the storage device 109 can be coupled to one circuit board.

In some embodiments, the circuit board can contain a series of conductive tracks, pads, and/or other features etched from one or more sheet layers of copper laminate laminated onto and/or between sheet layers of nonconductive substrate. The conductive features can be part of the system bus 107 communicatively linking the various components of the electronic computing device 101. In some embodiments, the circuit board can be a printed circuit board. In some embodiments, the circuit board can be a motherboard.

### Multiple Electronic Computing Devices Communicatively Linked

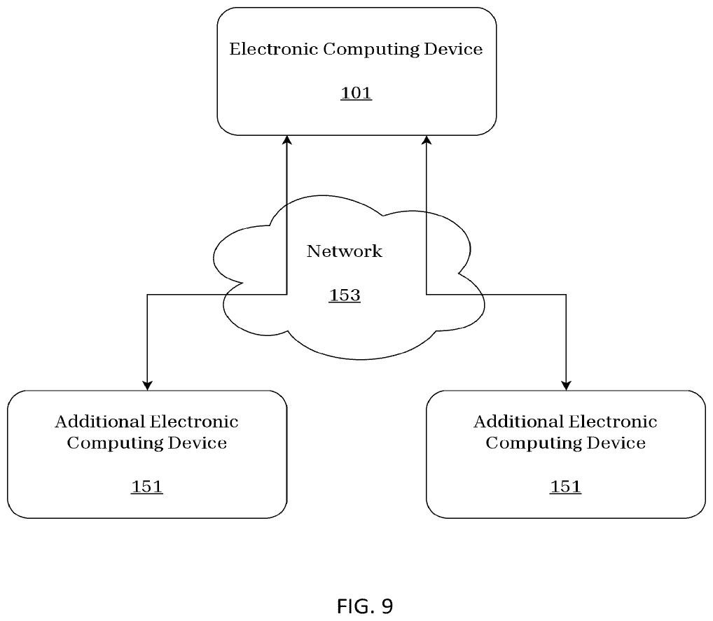

Referring to FIG. 9, The electronic computing device 101 can be communicatively linked to and/or controlled by one or more additional electronic computing devices 151. For example, the additional electronic computing device(s) 151 can be used to send data to or receive data from the electronic computing device 101. The additional electronic computing device(s) 151 can also be used to control or operate the electronic computing device 101. For example, the additional electronic computing device(s) 151 can be used to control the electronic computing device 101 to perform any of the methods, processes, or other operations described above.

The additional electronic computing device(s) 151 can be the same as or similar to the electronic computing device 101. The additional electronic computing device(s) 151 can also be a different device than the electronic computing device 101 even though it can have any of the components and/or features described in connection with the electronic computing device 101. The additional electronic computing device 151 can be a mobile electronic computing device, a personal electronic computing device, a wearable electronic computing device, a general-purpose electronic computing device, a special-purpose electronic computing device (e.g., designed for a specific purpose, application, or field of applications), an industrial electronic computing device, or the like.

By way of example, the additional electronic computing device 151 can be a mobile electronic computing device such as a mobile phone, smartphone, tablet computer, handheld personal computer, or the like. The additional electronic computing device 151 can also be a personal electronic computing device such as a laptop computer, desktop computer, or workstation. The additional electronic computing device 151 can also be a wearable electronic computing device such as a smartwatch, smartband, smartglasses, or the like. The additional electronic computing device 151 can also be an industrial electronic computing device such as a programmable logic controller, system on a module, or the like.

The electronic computing device 101 can be communicatively linked with the additional electronic computing device(s) 151 using any suitable wired or wireless communication protocol. For example, the electronic computing devices 101, 151 can communicate using one or more of the following wired communication protocols: ethernet, HDMI, SATA, CAN, RS-232, RS-485, UART, USART, USB, or the like. The electronic computing devices 101, 151 can communicate using one or more of the following wireless communication protocols: Wi-Fi®, BLUETOOTH®, BLUETOOTH® Low Energy, Zigbee®, Z-Wave®, GSM/GPRS, CDMA, NFC, RFID, 6LoWPAN, or the like.

The additional electronic computing device(s) 151 can be connected directly to the electronic computing device 101 without connecting to any intermediate electronic computing devices, or the additional electronic computing device(s) 151 can be connected to the electronic computing device 101 by way of one or more intermediate electronic computing devices—e.g., a network 153. Likewise, the additional electronic computing device(s) 151 can be positioned adjacent to or nearby the electronic computing device 101 (e.g., same room, line of sight, etc.), or it can be positioned remotely relative to the electronic computing device 101 (e.g., different rooms, out of sight, different continents, etc.).

In one example, the additional electronic computing device 151 can be a mobile electronic computing device capable of running applications obtained from an app source (e.g., an app store) including an application designed to communicate with and/or control the electronic computing device 101. In another example, the additional electronic computing device 151 can be a personal electronic computing device such as a laptop computer capable of running software designed to communicate with and/or control the electronic computing device 101. It should be appreciated that there are numerous other ways the additional electronic computing device 151 can connect to, communicate with, and/or control the electronic computing device 101.

### Network Computing

One or more of the electronic computing devices 101, 151 can be part of or communicatively linked to a network 153 of computing devices having a variety of topologies. The network 153 can include a local area network (LAN), wide area network (WAN) or the Internet. The electronic computing devices 101, 151 on the network 153 can be similar and/or dissimilar to each other. The program instructions described above can be implemented by a single electronic computing device 101, 151 or by multiple electronic computing devices 101, 151 communicatively linked over the network 153.

The one or more electronic computing devices 101, 151 can be part of a wide variety of computer systems. In some embodiments, the one or more electronic computing devices 101, 151 can be part of or communicatively linked to a cloud computing environment. Cloud computing refers to a model for enabling ubiquitous, convenient, on-demand network access to a shared pool of configurable computing resources (e.g., networks, servers, storage, applications, and/or services) that can be rapidly provisioned via virtualization and released with minimal management effort or service provider interaction, and then scaled accordingly. A cloud computing environment can have a variety of characteristics (e.g., on-demand self-service, broad network access, resource pooling, rapid elasticity, measured service, etc.), service models (e.g., software as a service (“SaaS”), platform as a service (“PaaS”), infrastructure as a service (“IaaS”)), and deployment models (e.g., private cloud, community cloud, public cloud, hybrid cloud, etc.).

The one or more electronic computing devices 101, 151 can communicate with each other using a variety of network protocols—i.e., a set of rules for formatting and processing data. The use of network protocols makes it possible for electronic computing devices 101, 151 having vastly different software and hardware to communicate with each other.

### Network Interconnection Model

In general, network protocols take complex processes and divide them into smaller tasks or functions. These functions work at different layers of a network hierarchy to fulfill certain tasks that contribute to the overall operations of a network. Although there are different types of networks that use different protocol sequences, one common structure is based on the Open Systems Interconnection (OSI) model. The OSI model includes one or more of the following seven layers.
Physical layer: this is the first layer and it includes the tangible electronic computing device 101, 151 and its mechanical characteristics, which allow it to connect with a network.
Data link layer: the second layer handles data packaging by creating data packets, detecting packet transmission errors, and correcting the packet transmission errors.
Network layer: the third network layer manages the routes the electronic computing devices 101, 151 use to transfer data and controls how information travels along the network to prevent congestion and improve efficiency.
Transport layer: this layer is the fourth layer, where protocols manage the delivery of data packages over the network. Protocols at this layer can also recover or troubleshoot errors.
Session layer: layer five protocols handle user sessions by starting new sessions, ending completed sessions, and displaying dialogues for users to interact within the interface.
Presentation layer: the sixth layer of a network contains protocols that translate data from one format into another. For example, a first electronic computing device 101, 151 may send data to a second electronic computing device 101, 151 using a different coding or encryption type than that used by the second electronic computing device 101, 151. This layer decodes the data into a format that the second electronic computing device 101, 151 can use.
Application layer: the application layer uses protocols that provide services like file transfers and operations.

At each layer of the network, protocols determine how to carry out specific tasks. Multiple protocols can operate at each layer to initiate, coordinate, and fulfill each function. In an OSI, the lower layers of the network focus primarily on the transport of data between the electronic computing devices 101, 151. The higher layers—i.e., the session layer, presentation layer, and application layer—manage data application.

The following is a list of common classifications of network protocols with examples of each.

### Network Communication Protocols

A network communication protocol allows basic data transfers between networked electronic computing devices 101, 151. These protocols can communicate text-based files between two or more electronic computing devices 101, 151 or over a larger network such as the internet. They can also establish communication between routers and external or linked electronic computing devices 101, 151 in a network. Examples of network communication protocols include:
BLUETOOTH®: A BLUETOOTH® protocol can connect electronic computing devices 101, 151 that perform the same or different functions to each other. Examples of such electronic computing devices 101, 151 include laptops, mobile phones, cameras, printers, and tablets.
File transfer protocol (FTP): FTP protocols allow electronic computing devices 101, 151 to share files between hosts. They enable the electronic computing devices 101, 151 to share large files, resume sharing after an interruption, recover lost files, and schedule file transfers.
Transmission control protocol/internet protocol (TCP/IP): this protocol provides reliable delivery to applications and ensures that the message arrives at the correct location, on time and without duplication.
User datagram protocol (UDP): UDP is an alternative to TCP and also works with IP to transmit time-sensitive data. UDP allows low-latency data transmissions between network applications, making it especially suitable for VoIP or other audio and video requirements.
Hypertext transfer protocol (HTTP): a protocol used for distributed and collaborative hypermedia information systems that allow for sharing data like text files, images, and videos over the internet.
Simple mail transfer protocol (SMTP): the SMTP transfers emails between electronic computing devices 101, 151 and notifies the user of incoming electronic messages.
Address resolution protocol (ARP): ARP translates IP addresses to MAC addresses and vice versa so LAN endpoints can communicate with one another. ARP is used because IP and MAC addresses are different lengths.
Domain name system (DNS): DNS is a database that includes a website's domain name and its corresponding IP addresses. DNS translates a domain name into IP addresses. DNS also includes the DNS protocol, which is within the IP suite and details the specifications DNS uses to translate and communicate.
Dynamic host configuration protocol (DHCP): DHCP assigns IP addresses to network endpoints so they can communicate with other network endpoints over IP. Whenever an electronic computing device 101, 151 joins a network with a DHCP server for the first time, DHCP automatically assigns it an IP address and continues to do so each time an electronic computing device 101, 151 moves locations on the network.

### Network Security Protocols

These protocols ensure that data transmitted over a network remains secure. They prevent unauthorized users from accessing information by incorporating passwords, authentication systems, or data encryption. Encryption is the process that converts plain or standard text into a coded form so that unauthorized users can't read it. Network security protocols include:
Hypertext transfer protocol secure (HTTPS): this protocol works similarly to HTTP but uses encryption to ensure the secure communication of data over a network like the internet.
Secure sockets layer/transport layer security (SSL/TLS): SSL and TLS protocols also use encryption to secure information transferred between two electronic computing devices 101, 151 in a network. TLS is the most recent version of this protocol, though the term “SSL” is still often used to refer to this type of protocol.
Secured shell (SSH): the SSH protocol provides secure connections to a network and is the primary method of managing network devices at the command level, which is the level at which the user can control the operating system of an electronic computing device 101, 151.
Secure file transfer protocol (SFTP): SFTP allows for secure file access, transfer and management over a network.

### Network Management Protocols

Network management protocols define the procedures used to operate a network. This includes how networks function and their maintenance requirements. Management protocols apply to all the electronic computing devices 101, 151 in a network, including routers, servers, and computers. They coordinate operations between all the electronic computing devices 101, 151.

Network management protocols are important for maintaining the stability of connections between electronic computing devices 101, 151 in a network and the connections of individual electronic computing devices 101, 151 to the network. A user can implement a network protocol to troubleshoot issues with connectivity. Types of network management protocols include:
Simple network management protocol (SNMP): SNMP allows network administrators to evaluate a network's performance, identify network errors and troubleshoot problems.
Internet control message protocol (ICMP): this protocol can send error messages and information about an electronic computing device 101, 151 or a network's operations. They can announce an error and assist with troubleshooting tasks.
Telnet: Telnet works similarly to SSH. It is a method of managing electronic computing devices 101, 151 at the command level, but unlike SSH, it doesn't provide a secure connection to a network.

### GENERAL TERMINOLOGY AND INTERPRETATIVE CONVENTIONS

Any methods described in the claims or present disclosure should not be interpreted to require the steps to be performed in a specific order unless expressly stated otherwise or doing so is impossible. Also, the methods should be interpreted to provide support to perform the recited steps in any order unless expressly stated otherwise.

Certain features described in the context of separate embodiments can also be implemented in combination in a single embodiment. Conversely, various features described in the context of a single embodiment can also be implemented in multiple embodiments separately or in any suitable subcombination. Moreover, although features may be described in certain combinations and even initially claimed as such, one or more features from a claimed combination can be excised from the combination, and the claimed combination may be directed to a subcombination or variation of a subcombination.

The example configurations described in this disclosure do not represent all the examples that may be implemented or that are within the scope of the claims. The term “example” shall be interpreted to mean “serving as an example, instance, or illustration,” and not “preferred” or “advantageous over other examples.”

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The phrase “based on” shall be interpreted to refer to an open set of conditions unless unequivocally stated otherwise (e.g., based on only a given condition). For example, a step described as being based on a given condition may be based on the recited condition and one or more unrecited conditions.

The terms have, having, contain, containing, include, including, and characterized by should be interpreted to be synonymous with the terms comprise and comprising—i.e., the terms are inclusive or open-ended and do not exclude additional unrecited subject matter. The use of these terms should also be understood as disclosing and providing support for narrower alternative embodiments where these terms are replaced by “consisting of,” “consisting of the recited subject matter plus impurities and/or trace amounts of other materials,” or “consisting essentially of.”

Unless otherwise indicated, all numbers or expressions, such as those expressing dimensions, physical characteristics, or the like, used in the present disclosure (other than the claims) are understood to be modified in all instances by the term “approximately.” At the very least, and not as an attempt to limit the application of the doctrine of equivalents to the claims, each numerical parameter recited in the present disclosure or claims that is modified by the term “approximately” should be construed in light of the number of recited significant digits and/or by applying ordinary rounding techniques.

All disclosed ranges are to be understood to encompass and provide support for claims that recite any subranges or any individual values subsumed by each range. For example, a stated range of 1 to 10 should be considered to include and provide support for claims that recite any subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth), which values can be expressed alone or as a minimum value (e.g., at least 5.8) or a maximum value (e.g., no more than 9.9994).

All disclosed numerical values are to be understood as being variable from 0-100% in either direction and thus provide support for claims that recite such values (either alone or as a minimum or a maximum—e.g., at least <value> or no more than <value>) or any ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range expressed individually (e.g., 15.2), as a minimum value (e.g., at least 4.3), or as a maximum value (e.g., no more than 12.4).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this disclosure shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this disclosure should be considered a disclaimer or disavowal of claim scope.

None of the limitations in the claims should be interpreted as invoking 35 U.S.C. 112(f) unless the words “means for” or “step for” are explicitly recited in the claim.

Unless explicitly stated otherwise or otherwise apparent from context, terms such as “processing,” “computing,” “calculating,” “determining,” “displaying,” or the like, refer to the action and processes of an electronic computing device including a processor and memory.

The subject matter recited in the claims is not coextensive with and should not be interpreted to be coextensive with any embodiment, feature, or combination of features described or illustrated in this disclosure. This is true even if only a single embodiment of the feature or combination of features is illustrated and described.

### Joining or Fastening Terminology and Interpretative Conventions

The term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

The term “coupled” includes joining that is permanent in nature or releasable and/or removable in nature. Permanent joining refers to joining the components together in a manner that is not capable of being reversed or returned to the original condition. Releasable joining refers to joining the components together in a manner that is capable of being reversed or returned to the original condition.

Releasable joining can be further categorized based on the difficulty of releasing the components and/or whether the components are released as part of their ordinary operation and/or use. Quickly releasable joining (i.e., quick-release) refers to joining that that can be released without the use of tools. Readily or easily releasable joining refers to joining that can be readily, easily, and/or promptly released with little or no difficulty or effort. Some joining can qualify as both quickly releasable joining and readily or easily releasable joining. Other joining can qualify as one of these types of joining but not the other. For example, one type of joining may be readily or easily releasable but also require the use of a tool.

Non-quickly releasable joining (i.e., non-quick-release) refers to joining that can only be released with the use of tools. Difficult or hard to release joining refers to joining that is difficult, hard, or arduous to release and/or requires substantial effort to release. Some joining can qualify as both non-quickly releasable joining and difficult or hard to release joining. Other joining can qualify as one of these types of joining but not the other. For example, one type of joining may require the use of a tool but may not be difficult or hard to release.

The joining can be released or intended to be released as part of the ordinary operation and/or use of the components or only in extraordinary situations and/or circumstances. In the latter case, the joining can be intended to remain joined for a long, indefinite period until the extraordinary circumstances arise.

It should be appreciated that the components can be joined together using any type of fastening method and/or fastener. The fastening method refers to the way the components are joined. A fastener is generally a separate component used in a mechanical fastening method to mechanically join the components together. A list of examples of fastening methods and/or fasteners is given below. The list is divided according to whether the fastening method and/or fastener is generally permanent, readily released, or difficult to release.

Examples of permanent fastening methods include welding, soldering, brazing, crimping, riveting, stapling, stitching, some types of nailing, some types of adhering, and some types of cementing. Examples of permanent fasteners include some types of nails, some types of dowel pins, most types of rivets, most types of staples, stitches, most types of structural ties, and toggle bolts.

Examples of readily releasable fastening methods include clamping, pinning, clipping, latching, clasping, buttoning, zipping, buckling, and tying. Examples of readily releasable fasteners include snap fasteners, retainer rings, circlips, split pin, linchpins, R-pins, clevis fasteners, cotter pins, latches, hook and loop fasteners (VELCRO®), hook and eye fasteners, push pins, clips, clasps, clamps, zip ties, zippers, buttons, buckles, split pin fasteners, and/or confirmat fasteners.

Examples of difficult to release fastening methods include bolting, screwing, most types of threaded fastening, and some types of nailing. Examples of difficult to release fasteners include bolts, screws, most types of threaded fasteners, some types of nails, some types of dowel pins, a few types of rivets, a few types of structural ties.

It should be appreciated that the fastening methods and fasteners are categorized above based on their most common configurations and/or applications. The fastening methods and fasteners can fall into other categories or multiple categories depending on their specific configurations and/or applications. For example, rope, string, wire, cable, chain, or the like can be permanent, readily releasable, or difficult to release depending on the application.

### DRAWING RELATED TERMINOLOGY AND INTERPRETATIVE CONVENTIONS

Reference numbers in the drawings and corresponding description refer to identical or similar elements although such numbers may be referenced in the context of different embodiments.

The drawings are intended to illustrate embodiments that are both drawn to scale and/or not drawn to scale. This means the drawings can be interpreted, for example, as showing: (a) everything drawn to scale, (b) nothing drawn to scale, or (c) one or more features drawn to scale and one or more features not drawn to scale. Accordingly, the drawings can serve to provide support to recite the sizes, proportions, and/or other dimensions of any of the illustrated features either alone or relative to each other. Furthermore, all such sizes, proportions, and/or other dimensions are to be understood as being variable from 0-100% in either direction and thus provide support for claims that recite such values or any ranges or subranges that can be formed by such values.

Spatial or directional terms, such as “left,” “right,” “front,” “back,” or the like, relate to the subject matter as it is shown in the drawings and/or how it is commonly oriented during manufacture, use, or the like. However, it is to be understood that the described subject matter may assume various alternative orientations and, accordingly, such terms are not to be considered as limiting.

### COMPOSITION RELATED TERMINOLOGY AND INTERPRETATIVE CONVENTIONS

The description of a group or class of materials as suitable or preferred for a given purpose shall be understood as disclosing that a single member of the group or class or a mixture of any two or more members of the group or class are equally suitable or preferred.

The description of constituents in chemical terms refers to the constituents: (a) at the time of addition to any combination specified in the description and/or (b) generated in situ by chemical reactions with other constituents. The description of the constituents does not preclude other chemical interactions among the constituents of a mixture once mixed unless expressly stated otherwise.

The description of materials in ionic form additionally implies the presence of sufficient counter ions to produce electrical neutrality for the composition.

### INCORPORATION BY REFERENCE

The entire content of each document listed below is incorporated by reference into this disclosure (the documents below are collectively referred to as the “incorporated documents”). If the same term is used in both this disclosure and one or more of the incorporated documents, then it should be interpreted to have the broadest meaning imparted by any one or combination of these sources unless the term has been explicitly defined to have a different meaning in this disclosure. If there is an inconsistency between any incorporated document and this disclosure, then this disclosure shall govern. The incorporated subject matter should not be used to limit or narrow the scope of the explicitly recited or depicted subject matter.

Priority patent documents incorporated by reference:
U.S. Prov. App. No. 63/468,116, titled “Hybrid Electrochemical Systems and Methods for CO₂ Capture,” filed on 22 May 2023.

1.-103. (canceled)

104. A method for capturing carbon dioxide (CO₂) from a gas, the method comprising the successive execution of the following steps:
1) a first step of hydrating, within a hydrating unit with an air contactor, the CO₂ from the gas to dissolve the CO₂ into an electrolyte solution, thereby forming a CO₂-rich electrolyte solution;
2) a second step comprising a first sub-step and a second sub-step,
the first sub-step comprising feeding an electrochemical device with the CO₂-rich electrolyte solution obtained from the first step, the first sub-step being carried out so as deplete the CO₂-rich electrolyte solution of CO₂-derived ions and CO₂ gas to form a depleted electrolyte solution, the CO₂ derived ions and CO₂ gas depletion being effected by applying a bias voltage between electrodes including an anode and a cathode of the electrochemical device, thereby causing capture of the CO₂-derived ions and CO₂ gas by the electrodes;
the second sub-step comprising interrupting, removing, or inverting the bias voltage, thereby causing the CO₂-derived ions and CO₂ gas to be released from the electrodes and to recombine so as to regenerate gaseous CO₂.

105. The method of claim 104, wherein the depleted electrolyte solution is recirculated toward the hydrating unit.

106. The method of claim 105, wherein, during the execution of the first sub-step, the CO₂-rich electrolyte solution flows in the electrochemical device while the bias voltage is applied such that the CO₂-derived ions are captured by the electrodes, the CO₂-derived ions comprising H⁺, HCO₂⁻ and CO₃²⁻.

107. The method of claim 106, wherein, during execution of the first sub-step, H⁺ ions are CO₂ gas are captured at the cathode while the HCO₂⁻ and CO₃²⁻ ions are captured at the anode.

108. The method of claim 107, further comprising a third step carried out during the second sub-step and wherein the regenerated gaseous CO₂ is dehydrated and compressed, or is utilized without being previously compressed in one or more of chemical, physical, and/or biological processes.

109. The method of claim 108, wherein the electrolyte solution comprises one or more of water, a water-based solution, or an organic solvent-based solution.

110. The method of claim 109, wherein the first step is carried out in presence of a carbon dioxide hydration catalyst.

111. The method of claim 110, wherein the carbon dioxide hydration catalyst comprises carbonic anhydrase, advantageously, the carbonic anhydrase is immobilized on a surface.

112. The method of claim 111, wherein the carbonic anhydrase is immobilized on a surface.

113. The method of claim 111, wherein during execution of the method the electrochemical device generates or stores electrical energy.

114. The method of claim 104, wherein during the execution of the first sub-step the CO₂-rich electrolyte solution flows in the electrochemical device while the bias voltage is applied such that the CO₂-derived ions are captured by the electrodes, the CO₂-derived ions comprising H⁺, HCO₂⁻ and CO₃²⁻.

115. The method of claim 114, wherein during execution of the first sub-step H⁺ ions are CO₂ gas are captured at the cathode while the HCO₂⁻ and CO₃²⁻ ions are captured at the anode.

116. The method of claim 104, wherein the method further comprise a third step carried out during the second sub-step and wherein the regenerated gaseous CO₂ is dehydrated and compressed, or is utilized without being previously compressed in one or more of chemical, physical, and/or biological processes.

117. The method of claim 104, wherein the electrolyte solution comprises one or more of water, a water-based solution, or an organic solvent-based solution.

118. The method of claim 104, wherein the first step is carried out in presence of a carbon dioxide hydration catalyst.

119. The method of claim 118, wherein the carbon dioxide hydration catalyst comprises carbonic anhydrase.

120. The method of claim 119, wherein the carbonic anhydrase is immobilized on a surface.

121. The method of claim 104, wherein during execution of the method the electrochemical device generates or stores electrical energy.
